(19) United States
(12) Patent Application Publication
(10) Pub. No.: US 2025/0224772 A1
(43) Pub. Date: Jul. 10, 2025

(54) ELECTRONIC APPARATUS

(71) Applicant: Samsung Display Co., LTD., Yongin-si (KR)

(72) Inventors: SEUNGHWA HA, Yongin-si (KR); JUYEOP SEONG, Yongin-si (KR); JONGSEOK CHAE, Yongin-si (KR)

(21) Appl. No.: 18/956,057

(22) Filed: Nov. 22, 2024

(30) Foreign Application Priority Data
Jan. 9, 2024 (KR) 10-2024-0003398

(51) Int. Cl. G06F 1/16

(52) U.S. Cl. CPC G06F 1/1656; G06F 1/1616; G06F 1/1643; G06F 1/1652

(57) ABSTRACT

An electronic apparatus includes: a display module including a folding area foldable around a folding axis extending in a first direction, and a first non-folding area and a second non-folding area, which are spaced apart from each other with the folding area therebetween in a second direction crossing the first direction; a window disposed on the display module; a support plate disposed below the display module; and a housing in which the display module and the support plate are accommodated. The support plate includes: a bottom portion facing a lower portion of the housing; and sidewall portions, each of which is bent from the bottom portion to face a lateral portion of the housing. Each of the sidewall portions is disposed between a side surface of the display module and the lateral portion of the housing.

This application claims priority to Korean Patent Application No. 10-2024-0003398, filed on Jan. 9, 2024, and all the benefits accruing therefrom under 35 U.S.C. § 119, the content of which in its entirety is herein incorporated by reference.

### BACKGROUND

The present disclosure herein relates to an electronic apparatus.

Various electronic apparatuses such as televisions, mobile phones, tablet computers, and game consoles are developed. Recently, flexible electronic apparatuses each including a flexible display panel capable of sliding or being folded are developed. The flexible electronic apparatuses may be folded, rolled, or bent unlike rigid display apparatuses. The flexible electronic apparatuses, with the ability to transform into various shapes, may be portable regardless of sizes of existing screens to improve user's convenience.

Among the flexible electronic apparatuses, electronic apparatuses capable of being folded are desirable to maintain reliability and stability of members constituting the electronic apparatuses during folding. And taking it into account, peripheral areas on which images are displayed are designed. The peripheral areas of the electronic apparatuses may degrade display quality, and accordingly, method for reducing the peripheral areas is desirable.

### SUMMARY

The present disclosure provides an electronic apparatus which reduces a dead space to improve visibility.

The present disclosure also provides an electronic apparatus with improved impact resistance.

An embodiment of the invention provides an electronic apparatus including: a display module including a folding area foldable around a folding axis extending in a first direction, and a first non-folding area and a second non-folding area, which are spaced apart from each other with the folding area therebetween in a second direction crossing the first direction; a window disposed on the display module; a protective layer disposed on the window; a support plate disposed below the display module; and a housing in which the display module and the support plate are accommodated. The support plate includes: a bottom portion facing a lower portion of the housing; and sidewall portions, each of which is bent from the bottom portion to face a lateral portion of the housing. Each of the sidewall portions is disposed between a side surface of the display module and the lateral portion of the housing.

In an embodiment, the support plate may include: a matrix including a filler, and a reinforced fiber composite material disposed inside the matrix and including at least one of a reinforced fiber or a carbon fiber.

In an embodiment, the sidewall portions may be bent from the bottom portion with predetermined curvature.

In an embodiment, an angle between the bottom portion and each of the sidewall portions may be a right angle.

In an embodiment, the electronic apparatus may further include a lower plate disposed below the support plate, and the lower plate may have a plate shape extending in the first direction and the second direction.

In an embodiment, the lower plate may include at least one of stainless steel or aluminum.

In an embodiment, the lower plate may include: a first plate overlapping the first non-folding area, and a second plate spaced apart from the first plate with the folding area therebetween, and overlapping the second non-folding area.

In an embodiment, a sum of a thickness of the bottom portion of the support plate and a thickness of the lower plate may be about 50 micrometers (μm) to about 250 μm.

In an embodiment, the electronic apparatus may further include a cushion layer disposed between the side surface of the display module and each of the sidewall portions, and the cushion layer may be in contact with the sidewall portions.

In an embodiment, each of the sidewall portions may define a plurality of holes adjacent to a boundary of the bottom portion, and extending in the same direction as an extending direction of the boundary.

In an embodiment, the electronic apparatus may further include a cover tape that is disposed on an outside of the sidewall portions adjacent to the housing, and covers the holes.

In an embodiment, the electronic apparatus may further include a cushion layer disposed between the lateral portion of the housing and each of the sidewall portions, and the cushion layer may be in contact with the sidewall portions.

In an embodiment, the electronic apparatus may further include: a cushion layer, which is in contact with a top surface of each of the sidewall portions and an inner surface of each of the sidewall portions.

In an embodiment, the electronic apparatus may further include a printing layer disposed along an edge of the protective layer and having a predetermined color.

In an embodiment, a top surface of each of the sidewall portions may be in contact with the printing layer.

In an embodiment, the housing may further include a protruding portion protruding from a top surface of the lateral portion. The protruding portion may include a first surface facing the top surface of the lateral portion, a second surface that connects the first surface to an outer surface of the lateral portion, and a third surface that connects the first surface to the top surface of the lateral portion. An angle between the second surface and the first surface may be an obtuse angle, and an angle between the third surface and the first surface may be a right angle.

In an embodiment, the first surface may be parallel to the top surface of the lateral portion.

In an embodiment, the first surface and the protective layer may not overlap each other in a plan view.

In an embodiment, the first surface may have predetermined curvature.

In an embodiment, the protective layer may be disposed on a portion, which is exposed from the protruding portion, of the top surface of the lateral portion.

In an embodiment, the display module may include a first area including the first non-folding area, the folding area, and the second non-folding area, a bending area, and a second area, which are arranged in the second direction. The bending area may be bent around a bending axis extending in the first direction such that the second area overlaps the first area in a plan view, and a width of the first area may be greater than a width of each of the bending area and the second area in the first direction.

In an embodiment, the sidewall portions may be spaced apart from each other with the bending area therebetween in a state in which the bending area is bent.

In an embodiment, the electronic apparatus may further include a support part disposed on the lower portion of the housing, which is adjacent to the bending area.

In an embodiment, the sidewall portions may not be disposed on an area overlapping the folding area.

In an embodiment of the invention, an electronic apparatus includes: a display module including a folding area foldable around a folding axis extending in a first direction, and a first non-folding area and a second non-folding area, which are spaced apart from each other with the folding area therebetween in a second direction crossing the first direction; a window disposed on the display module; a protective layer disposed on the window; a lower film disposed below the display module; a support plate disposed below the lower film and defining a groove recessed in at least a portion of the support plate; a coupling part extending along an edge of the support plate and including a protrusion portion coupled to the groove; and a housing in which the display module and the support plate are accommodated. The coupling part is disposed between a side surface of the display module and the housing.

In an embodiment, each of the groove and the protrusion portion may be provided in plurality, and the plurality of grooves may be arranged to be spaced apart from each other along an edge of the support plate. The coupling part may include a body extending along the edge of the support plate, and protrusion portions protruding from the body, and the protrusion portions may be inserted into the grooves, respectively.

In an embodiment, the groove may extend along the edge of the support plate, and the coupling part may include a resin.

### BRIEF DESCRIPTION OF THE FIGURES

The accompanying drawings are included to provide a further understanding of the invention, and are incorporated in and constitute a part of this specification. The drawings illustrate embodiments of the invention and, together with the description, serve to explain principles of the invention. In the drawings:

FIG. 1A is a perspective view illustrating an electronic apparatus according to an embodiment;

FIG. 1B is a perspective view illustrating an electronic apparatus according to an embodiment;

FIG. 1C is a perspective view illustrating an electronic apparatus according to an embodiment;

FIG. 1D is a perspective view illustrating an electronic apparatus according to an embodiment;

FIG. 2A is a perspective view illustrating an electronic apparatus according to an embodiment;

FIG. 2B is a perspective view illustrating an electronic apparatus according to an embodiment;

FIG. 2C is a perspective view illustrating an electronic apparatus according to an embodiment;

FIG. 3 is an exploded perspective view illustrating an electronic apparatus according to an embodiment;

FIG. 4 is a cross-sectional view illustrating a portion corresponding to line I-I′ in FIG. 3;

FIG. 5 is a plan view of a display panel according to an embodiment;

FIG. 6A is a development view of a support plate according to an embodiment;

FIG. 6B is a perspective view of a support plate according to an embodiment;

FIG. 7A is a cross-sectional view of one portion of an electronic apparatus according to an embodiment;

FIG. 7B is a cross-sectional view of another portion of an electronic apparatus according to an embodiment;

FIG. 8A is a plan view of a support plate according to an embodiment;

FIG. 8B is a perspective view of a support plate according to an embodiment;

FIG. 9A is a plan view of a support plate according to an embodiment;

FIG. 9B is a perspective view of a support plate according to an embodiment;

FIG. 10A is a cross-sectional view of one portion of an electronic apparatus according to an embodiment;

FIG. 10B is a cross-sectional view of another portion of an electronic apparatus according to an embodiment;

FIG. 10C is a plan view of plates according to an embodiment;

FIG. 11A is a cross-sectional view of one portion of an electronic apparatus according to an embodiment;

FIG. 11B is a development view of a support plate according to an embodiment;

FIG. 12A is a cross-sectional view of one portion of an electronic apparatus according to an embodiment;

FIG. 12B is a perspective view of a support plate and a coupling part according to an embodiment;

FIG. 12C is a perspective view of a state in which a support plate and a coupling part are coupled to each other according to an embodiment;

FIG. 13A is a cross-sectional view of one portion of an electronic apparatus according to an embodiment;

FIG. 13B is a perspective view of a support plate according to an embodiment;

FIG. 14A is a cross-sectional view of a state in which a support plate and a coupling part are coupled to each other according to an embodiment;

FIG. 14B is a perspective view of a support plate according to an embodiment;

FIG. 15A is a cross-sectional view of one portion of an electronic apparatus according to an embodiment;

FIG. 16 is a cross-sectional view of one portion of an electronic apparatus according to an embodiment; and

FIG. 17 is a cross-sectional view of one portion of an electronic apparatus according to an embodiment.

### DETAILED DESCRIPTION

In this specification, it will be understood that when an element (or region, layer, section, etc.) is referred to as being “on,” “connected to” or “coupled to” another element, it can be disposed directly on, connected or coupled to the other element or a third element may be disposed between the elements.

Like reference numbers or symbols refer to like elements throughout. In addition, in the drawings, the thickness, the ratio, and the dimension of elements are exaggerated for effective description of the technical contents. The term “and/or” includes one or more combinations which may be defined by relevant elements.

It will be understood that, although the terms “first”, “second”, etc. may be used herein to describe various elements, these elements should not be limited by these terms. These terms are only used to distinguish one element from another element. For example, a first element could be termed a second element without departing from the teachings of the present invention, and similarly, a second element could be termed a first element. As used herein, the singular forms are intended to include the plural forms as well, unless the context clearly indicates otherwise.

In addition, the terms, such as “below”, “beneath”, “on” and “above”, are used for explaining the relation of elements shown in the drawings. The terms are relative concept and are explained based on the direction shown in the drawing.

It will be further understood that the terms such as “includes” or “has”, when used herein, specify the presence of stated features, numerals, steps, operations, elements, parts, or the combination thereof, but do not preclude the presence or addition of one or more other features, numerals, steps, operations, elements, parts, or the combination thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

“At least one” is not to be construed as limiting “a” or “an.” “Or” means “and/or.” As used herein, the term “and/or” includes any and all combinations of one or more of the associated listed items. “at least one of A, B, or C” includes “A”, “B”, “C”, “A and B”, “A and C”, “B and C” and/or “A, B, and C”. Hereinafter, embodiments of the invention will be described with reference to the accompanying drawings.

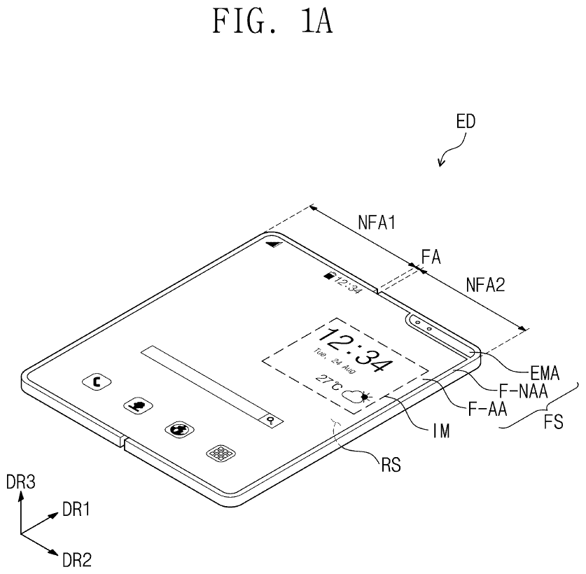

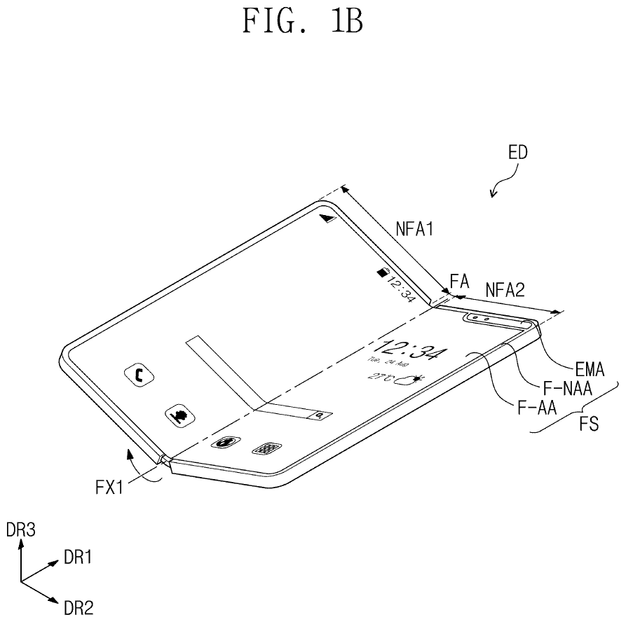

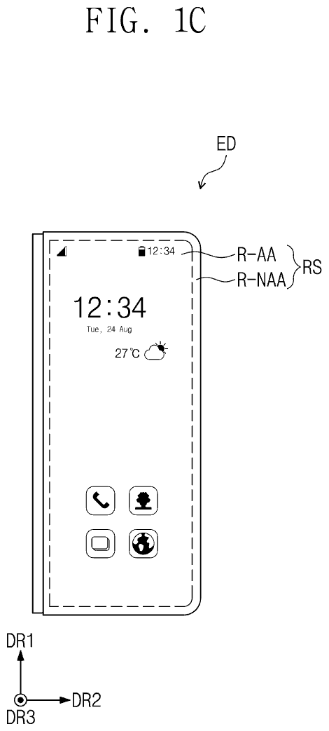

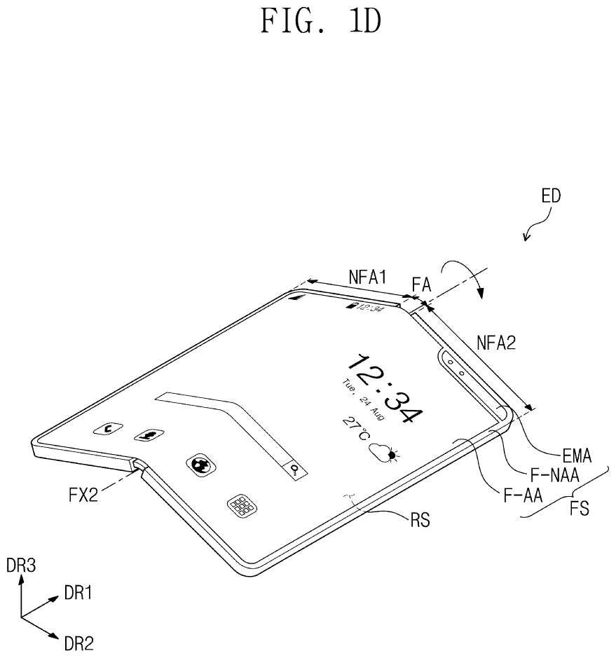

FIG. 1A is a perspective view illustrating an electronic apparatus according to an embodiment. FIG. 1B is a perspective view illustrating an electronic apparatus according to an embodiment. FIG. 1C is a perspective view illustrating an electronic apparatus according to an embodiment. FIG. 1D is a perspective view illustrating an electronic apparatus according to an embodiment.

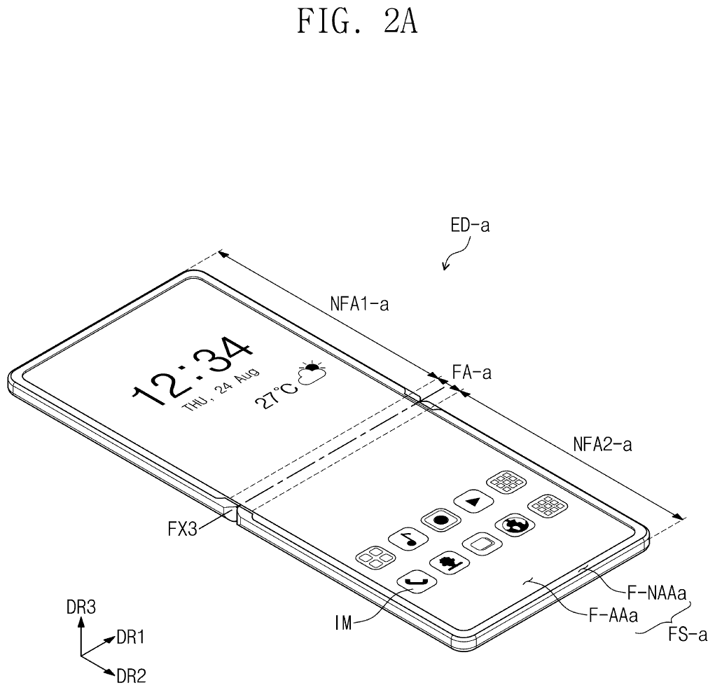

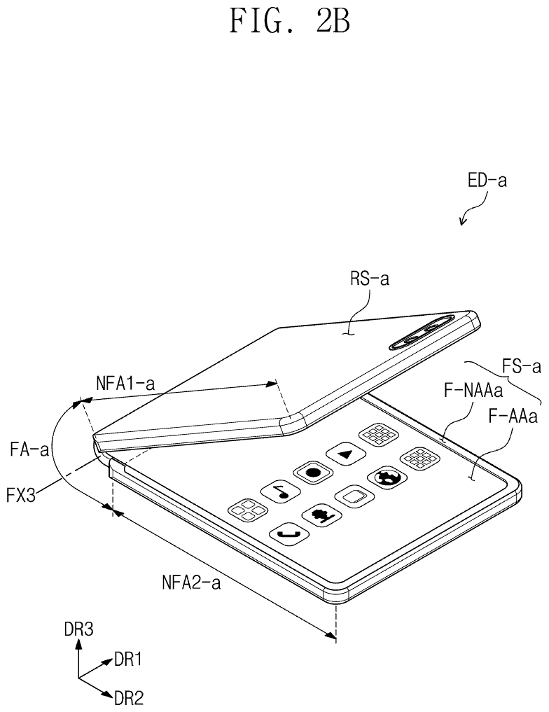

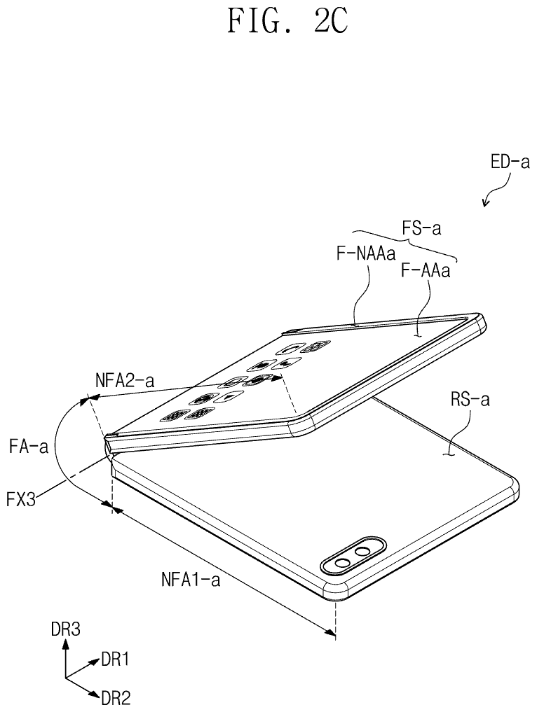

FIG. 1A is a perspective view of a spread state of an electronic apparatus ED according to an embodiment. The electronic apparatus ED according to an embodiment may be an apparatus that is activated in response to an electrical signal. For example, the electronic apparatus ED may be a mobile phone, a tablet computer, a vehicle navigation unit, a game console, or a wearable device, but an embodiment is not limited thereto. FIGS. 1A to 2C illustrate foldable electronic apparatuses ED and ED-a as an example. The foldable electronic apparatuses ED and ED-a according to an embodiment may be mobile phones.

The electronic apparatus ED may include a first display surface FS defined by a first directional axis DR1 and a second directional axis DR2 crossing the first directional axis DR1. The electronic apparatus ED may provide an image IM for a user through the first display surface FS. The electronic apparatus ED may display the image IM in a direction of a third directional axis DR3 on the first display surface IM parallel to each of the first directional axis DR1 and the second directional axis DR2.

In the present disclosure, the first directional axis DR1 and the second directional axis DR2 may be perpendicularly cross each other, and the third directional axis DR3 may be a normal direction to a plane defined by the first directional axis DR1 and the second directional axis DR2. A thickness direction of the electronic apparatus ED may be a direction parallel to the third directional axis DR3. A front surface (or top surface) and a rear surface (or bottom surface) may oppose each other with respect to the third directional axis DR3, and a normal direction to each of the front surface (or top surface) and the rear surface (or bottom surface) may be parallel to the third directional axis DR3. The front surface (or top surface) means a surface close to the first display surface FS, and the rear surface (or bottom surface) means a surface spaced apart from the first display surface FS. In addition, the rear surface (or bottom surface) means a surface close to a second display surface RS to be described later. The term above (or upper) means a direction that is close to the first display surface FS, and the term below (or lower) means a direction that is away from the first display surface FS.

A cross-section of each of components means a surface parallel to a thickness direction DR3, and a plane thereof means a surface perpendicular to the thickness direction DR3. The plane means a surface defined by the first directional axis DR1 and the second directional axis DR2. As used herein, the “plan view” is a view in a thickness direction (i.e., third direction DR3) of a display module DM or the electronic apparatus ED.

Directions indicated by the first to third directional axes DR1, DR2 and DR3 used herein are relative concepts and may be changed to other directions. In addition, the directions indicated by the first to third directional axes DR1, DR2 and DR3 may be referred to as first to third directions, and may be designated by like reference numbers or symbols.

The electronic apparatus ED may detect an external input applied from the outside. The external input may include various types of inputs provided from the outside of the electronic apparatus ED. For example, the external input may include not only a touch by part of the body, such as a user's hand, but also an external input (e.g., hovering) applied by approaching the electronic apparatus ED or being adjacent thereto by a predetermined distance. In addition, the external input may include various types such as force, pressure, temperature, and light.

The electronic apparatus ED may include the first display surface FS and the second display surface RS. The first display surface FS may include a first active area F-AA, a first peripheral area F-NAA, and an electronic module area EMA. The second display surface RS may be defined as a surface opposing at least a portion of the first display surface FS. That is, the second display surface RS may be defined as a portion of a rear surface of the electronic apparatus ED.

The first active area F-AA may be an area that is activated in response to an electrical signal. The first active area F-AA may be an area on which the image IM is displayed, and which is capable of detecting various types of external inputs.

The first peripheral area F-NAA may be an area on which the image IM is not displayed. The first peripheral area F-NAA may be adjacent to the first active area F-AA. The first peripheral area F-NAA may have a predetermined color. The first peripheral area F-NAA may surround the first active area F-AA. Accordingly, a shape of the first active area F-AA may be substantially defined by the first peripheral area F-NAA. However, this is an example, and the first peripheral area F-NAA may be disposed to be adjacent to only one side of the first active area F-AA, or may be omitted.

Various electronic modules may be disposed on the electronic module area EMA. For example, the electronic modules may include at least one of a camera, a speaker, a light detecting sensor, or a heat detecting sensor. The electronic module area EMA may detect an external subject received through the display surfaces FS and RS, or provide the outside with a sound signal such as voice, through the display surfaces FS and RS. Each of the electronic modules may include a plurality of components, and is not limited to any one embodiment.

The electronic module area EMA may be surrounded by the first peripheral area F-NAA. However, this is an example, and the electronic module area EMA is not limited to any one embodiment. For example, the electronic module area EMA may be surrounded by the first active area F-AA and the first peripheral area F-NAA, and the electronic module area EMA may be disposed within the first active area F-AA.

The electronic apparatus ED according to an embodiment may be divided into at least one folding area FA, and a plurality of non-folding areas NFA1 and NFA2 each extending from the folding area FA. For example, a first non-folding area NFA1, the folding area FA, and a second non-folding area NFA2 may be defined in a second direction DR2. The electronic apparatus ED may be divided into the first non-folding area NFA1 and the second non-folding area NFA2, which are spaced apart from each other in the second direction DR2, with the folding area FA therebetween. For example, the first non-folding area NFA1 may be disposed at one side of the folding area FA in the second direction DR2, and the second non-folding area NFA2 may be disposed at the other side of the folding area FA in the second direction DR2.

FIG. 1A illustrates an embodiment of the electronic apparatus ED including one folding area FA. However, an embodiment is not limited thereto, and a plurality of folding areas may be defined in the electronic apparatus ED in another embodiment. For example, the electronic apparatus according to an embodiment may include two or more folding areas, and three or more non-folding areas disposed with each of the folding areas therebetween.

FIG. 1B is a perspective view illustrating a folding operation of the electronic apparatus ED according to an embodiment. FIG. 1C is a plan view of a folded state of the electronic apparatus ED according to an embodiment. FIG. 1D is a perspective view illustrating a folding operation of the electronic apparatus ED according to an embodiment.

Referring to FIG. 1B, the electronic apparatus ED according to an embodiment may be folded around a first folding axis FX1 extending in a first direction DR1. In a state in which the electronic apparatus ED is folded, the folding area FA may have predetermined curvature and a predetermined radius of curvature. The electronic apparatus ED may be folded around the first folding axis FX1 to be changed into an in-folded state so that the first non-folding area NFA1 and the second non-folding area NFA2 face each other, and the first display surface FS is not exposed to the outside.

Referring to FIG. 1C, the second display surface RS may be visible to a user in a state in which the electronic apparatus ED according to an embodiment is in-folded. Here, the second display surface RS may include a second active area R-AA that displays an image. The second active area R-AA may be an area that is activated in response to an electrical signal. The second active area R-AA may be an area on which an image is displayed, and which is capable of detecting various types of external inputs.

In addition, the second display surface RS may include a second peripheral area R-NAA. The second peripheral area R-NAA may be adjacent to the second active area R-AA. The second peripheral area R-NAA may have a predetermined color. The second peripheral area R-NAA may surround the second active area R-AA. Although not illustrated, the second display surface RS of the electronic apparatus ED may also further include an electronic module area on which an electronic module including various components is disposed, and is not limited to any one embodiment.

According to an embodiment, in the state in which the electronic apparatus ED is in-folded, a distance between the first non-folding area NFA1 and the second non-folding area NFA2 may be less than a radius of a circle defined by the radius of curvature of the folding area FA. Here, the folding area FA may be folded in a dumbbell shape, and the distance between the first non-folding area NFA1 and the second non-folding area NFA2 may be decreased. Thus, the electronic apparatus ED that is made slimmer in the folded state may be provided.

Referring to FIG. 1D, the electronic apparatus ED according to an embodiment may be foldable around a second folding axis FX2 extending in the first direction DR1. The electronic apparatus ED may be folded around the second folding axis FX2 to be changed into an out-folded state so that the first display surface FS is exposed to the outside. In an embodiment, the electronic apparatus ED may be provided to repeat an operation from a spreading operation to an in-folding or out-folding operation, or vice versa. However, an embodiment of the invention is not limited thereto.

The folding around one folding axis (FX1 or FX2) is described as an example with reference to FIGS. 1A to 1D, but the number of the folding axis and the number of non-folding areas accordingly are not limited thereto. For another example, folding may be performed around a plurality of folding axes so that a portion of the first display surface FS and a portion of the second display surface RS face each other. In addition, the first and second folding axes FX1 and FX2, each of which is parallel to a long side of the electronic apparatus ED, are illustrated, but an embodiment is not limited thereto. For another example, the first and second folding axes FX1 and FX2 may be parallel to a short side of the electronic apparatus ED.

In the electronic apparatus ED, the first non-folding area NFA1 and the second non-folding area NFA2 may each be defined as a portion having the display surfaces FS and RS parallel to a plane defined by the first directional axis DR1 and the second directional axis DR2 in the folded state as illustrated in FIG. 1C. The folding area FA may be defined as an area between the first non-folding area NFA1 and the second non-folding area NFA2. The folding area FA may include a curved portion that is bent to have predetermined curvature in the folded state.

FIG. 2A is a perspective view illustrating an electronic apparatus according to an embodiment. FIG. 2B is a perspective view illustrating an electronic apparatus according to an embodiment. FIG. 2C is a perspective view illustrating an electronic apparatus according to an embodiment.

FIGS. 2A to 2C are perspective views illustrating an electronic apparatus ED-a according to another embodiment of the invention. FIG. 2A is a perspective view illustrating a spread state of the electronic apparatus ED-a. FIGS. 2B and 2C are perspective views illustrating a folding operation of the electronic apparatus ED-a. FIG. 2B is a perspective view illustrating an in-folding operation of the electronic apparatus ED-a illustrated in FIG. 2A. FIG. 2C is a perspective view illustrating an out-folding operation of the electronic apparatus ED-a illustrated in FIG. 2A. FIG. 2A may be a view illustrating the electronic apparatus ED-a in a second mode.

Referring to FIG. 2A, the electronic apparatus ED-a may be foldable around a third folding axis FX3 extending in the first direction DR1. The extending direction of the third folding axis FX3 may be parallel to an extending direction of a short side of the electronic apparatus ED-a.

The electronic apparatus ED-a may be divided into a folding area FA-a, a first non-folding area NFA1-a adjacent to one side of the folding area FA-a, and a second non-folding area NFA2-a adjacent to the other side of the folding area FA-a. The first non-folding area NFA1-a and the second non-folding area NFA2-a may be spaced apart from each other with the folding area FA-a therebetween.

The folding area FA-a may be an area that is foldable around the third folding axis FX3. In a state in which the electronic apparatus ED-a is folded, the folding area FA-a may have predetermined curvature and a predetermined radius of curvature. The electronic apparatus ED-a may be in-folded so that the first non-folding area NFA1-a and the second non-folding area NFA2-a face each other, and a display surface FS-a is not exposed to the outside.

Referring to FIG. 2A, in an embodiment, the display surface FS-a may be visible to a user in a state in which the electronic apparatus ED-a is spread (i.e., non-folded state). As described with reference to FIGS. 1A to 1D, the display surface FS-a of the electronic apparatus ED-a may include an active area F-AAa and a peripheral area F-NAAa. The active area F-AAa may be an area on which an image IM is displayed, and which is capable of detecting various types of external inputs.

Referring to FIG. 2B, a rear surface RS-a of the electronic apparatus ED-a according to an embodiment may be visible to a user in the in-folded state. For example, the rear surface RS-a may function as a second display surface that displays an image. In addition, an electronic module area on which an electronic module including various components is disposed may be disposed also in the rear surface RS-a. According to an embodiment, the rear surface RS-a of the electronic apparatus ED-a may further include an active area on which an image is displayed.

Referring to FIG. 2C, the electronic apparatus ED-a may be folded around the third folding axis FX3 to be changed into an out-folded state so that one area, which overlaps the first non-folding area NFA1-a, of the rear surface RS-a and the other area, which overlaps the second non-folding area NFA2-a, of the rear surface RS-a face each other.

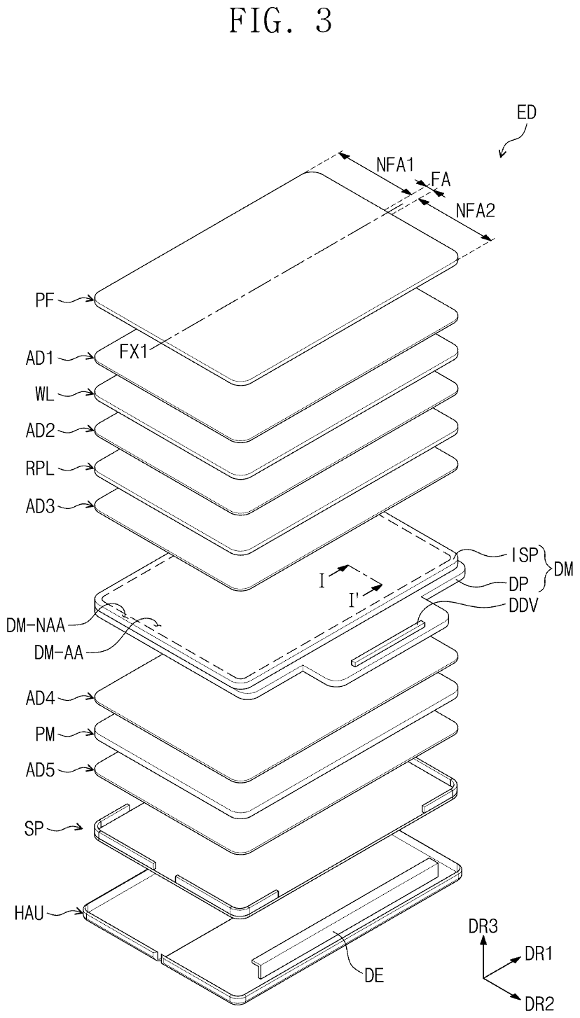

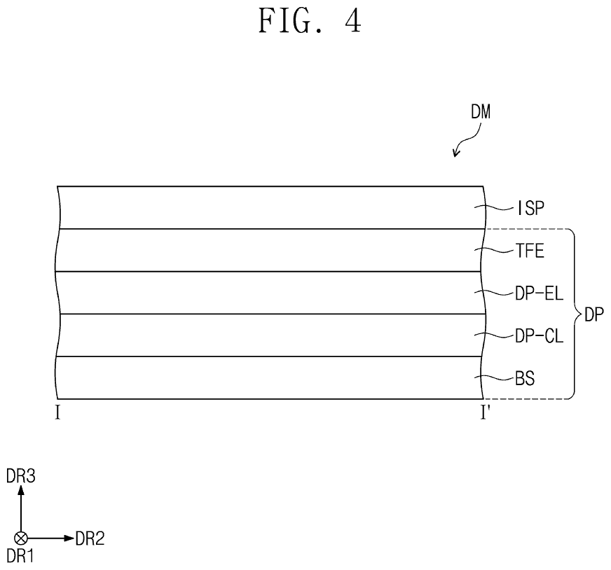

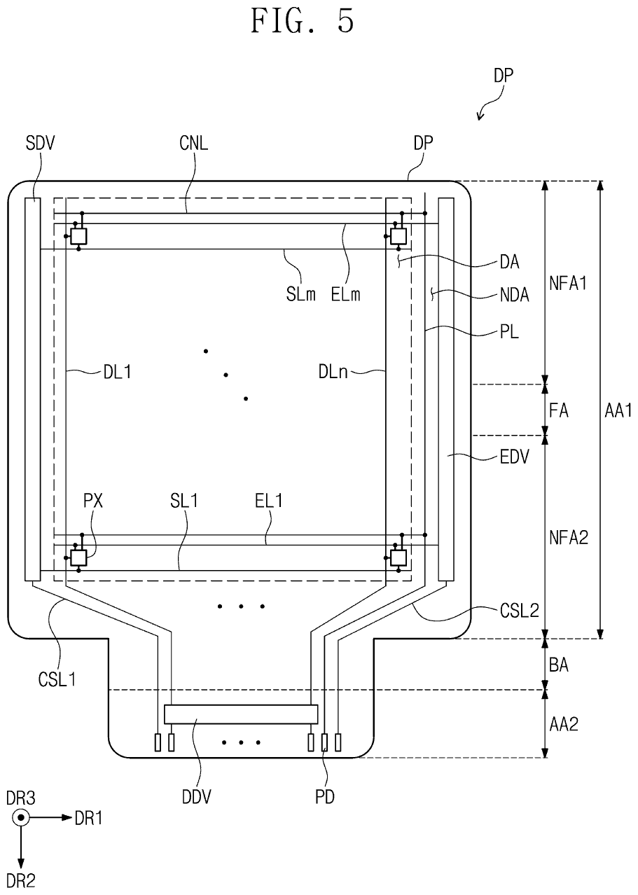

FIG. 3 is an exploded perspective view illustrating an electronic apparatus according to an embodiment. FIG. 4 is a cross-sectional view illustrating a portion corresponding to line I-I′ in FIG. 3. FIG. 5 is a plan view of a display panel according to an embodiment. Characteristics to be described below with respect to an electronic apparatus ED may apply to the electronic apparatus ED-a described with reference to FIGS. 2A to 2C.

Referring to FIG. 3, the electronic apparatus ED may include a protective layer PF, a window WL, a display module DM, an optical layer RPL, a lower film PM, a support plate SP, a support part DE, and a housing HAU.

The housing HAU may be coupled to the protective layer PF to define an outer appearance of the electronic apparatus ED. The housing HAU may include a material having relatively high rigidity. For examples, the housing HAU may include a plurality of frames and/or support plates, each of which is made of glass, plastic, or metal. The housing HAU may provide a predetermined accommodation space. The display module DM may be accommodated in the accommodation space to be protected against an external impact.

The display module DM may be activated in response to an electrical signal. The display module DM may be activated to display the image IM (see FIG. 1A) on the active area F-AA (see FIG. 1A) of the electronic apparatus ED. A display area DM-AA and a non-display area DM-NAA may be defined in the display module DM. The display area DM-AA may be an area that is activated in response to an electrical signal. The non-display area DM-NAA may be an area that is disposed to be adjacent to at least one side of the display area DM-AA. A circuit, a line, or the like for driving the display area DM-AA may be disposed in the non-display area DM-NAA.

The optical layer RPL may be disposed between the display module DM and the window WL. The optical layer RPL may be an anti-reflection layer that reduces reflectance of external light incident from the outside of the display module DM. The optical layer RPL may be formed on the display module DM through a continuous process. The optical layer RPL may include a polarizing plate, or include a color filter layer. For example, the optical layer RPL may include at least one of a retarder, a polarizer, a polarizing film, or a polarizing filter. Alternatively, the optical layer RPL may include a plurality of color filters disposed in a predetermined arrangement, and a black matrix adjacent to the color filters.

The image IM (see FIG. 1A) generated in the display module DM may be transmitted by the window WL to be provided for a user. The window WL may include an optically transparent insulation material. The window WL may include a polymer substrate or a glass substrate.

The window WL may be made of polyimide, polyacrylate, polymethylmethacrylate, polycarbonate, polyethylene naphthalate, polyvinylidene chloride, polyvinylidene difluoride, polystyrene, ethylene vinyl alcohol copolymer, or a combination thereof.

However, this is an example, and a material included in the window WL is not limited to the foregoing materials. For example, the window WL may be a strengthened glass substrate processed by a strengthening treatment. The window WL may include ultra thin glass (“UTG”).

The protective layer PF may be a functional layer that protects one surface of the window WL. The protective layer PF may include a polymer film. The protective layer PF may include an anti-fingerprint coating agent, a hard coating agent, an antistatic agent, or the like.

The lower film PM may protect a lower portion of a display panel DP. The lower film PM may include a flexible plastic material. For example, the lower film PM may include a polyethylene terephthalate material.

The support plate SP may be disposed below the display panel DP. A portion of the support plate SP according to an embodiment of the invention may be bent to absorb an impact applied between the housing HAU components and components disposed on the support plate SP. In addition, the support plate SP may prevent foreign matters or the like from being introduced into the components disposed on the support plate SP. This will be described later.

According to an embodiment of the invention, the support plate SP may include a matrix including a filler, and fiber lines which are disposed inside the matrix and have a woven shape. The fiber lines may be disposed in a fabric shape inside the matrix.

The fiber lines may include a reinforced fiber composite material. The reinforced fiber composite material may be at least one of carbon fiber-reinforced plastics (“CFRP”) or glass fiber-reinforced plastic (“GFRP”). A single strand of fiber included in one fiber line may have a diameter of about 3 micrometers (μm) to about 10 μm.

The matrix according to an embodiment may include at least one of epoxy, polyester, polyamides, polycarbonates, polypropylene, polybutylene, or vinyl ester.

The matrix may include the filler. The filler may include at least one of silica, barium sulphate, sintered talc, barium titanate, titanium oxide, clay, alumina, mica, boehmite, zinc borate, or zinc stannate.

The electronic apparatus ED according to an embodiment may further include the support part DE disposed on one side of the housing HAU. The support part DE may be disposed at a portion at which the support plate SP is not bent. In addition, the support part DE may be disposed on a lower portion of the housing HAU adjacent to a bending area BA (see FIG. 5), which is bent, of the display panel DP so as to prevent an impact applied to the bending area BA (see FIG. 5).

The electronic apparatus ED according to an embodiment may further include at least one of a cushion layer or a shielding layer. The cushion layer may prevent the support plate SP from being pressed or plastically deformed by an external impact and force. The cushion layer may include an elastomer such as sponge, foam, or a urethane resin. The cushion layer may include at least one of an acrylic polymer, a urethane-based polymer, a silicon-based polymer, or an imide-based polymer. The shielding layer may be an electromagnetic shielding layer or a heat dissipating layer.

The electronic apparatus ED according to an embodiment may further include first to fifth adhesive layers AD1 to AD5. The first adhesive layer AD1 may be disposed between the window WL and the protective layer PF. The second adhesive layer AD2 may be disposed between the optical layer RPL and the window WL. The third adhesive layer AD3 may be disposed between the display module DM and the optical layer RPL. The fourth adhesive layer AD4 may be disposed between the lower film PM and the display module DM. The fifth adhesive layer AD5 may be disposed between the support plate SP and the lower film PM.

Each of the first to fifth adhesive layers AD1 to AD5 and adhesive layers to be described later may include a common adhesive such as pressure sensitive adhesive (“PSA”), optically clear adhesive (“OCA”), or optical clear resin (“OCR”), and is not limited to any one embodiment. In the electronic apparatus ED according to an embodiment, at least one of the first to fifth adhesive layers AD1 to AD5 may be omitted.

When the electronic apparatus ED is folded, a slip of components of the electronic apparatus ED on the adhesive layers occurs. Upon folding, components of the electronic apparatus ED slip in the second direction DR2 perpendicular to the first direction DR1 in which the first folding axis FX1 extends, and in light of this phenomenon, members constituting the electronic apparatus ED may be disposed with a predetermined space from the housing HAU so that the members are not impacted by contact with the housing HAU.

Accordingly, the members such as the display panel DP, constituting the electronic apparatus ED may be spaced a predetermined distance from the housing HAU in the second direction DR2. The predetermined space corresponds to a portion of the first peripheral area F-NAA (see FIG. 1A).

Referring to FIG. 4, the display module DM may include the display panel DP and an input sensing layer ISP disposed on the display panel DP. The display panel DP may be a component that substantially generates an image. The display panel DP may be a light emitting display panel. For example, the display panel DP may be an organic light emitting display panel, an inorganic light emitting display panel, a micro LED display panel, a micro OLED display panel, or a nano LED display panel.

The display panel DP may include a base layer BS, a circuit layer DP-CL, a display element layer DP-EL, and an encapsulation layer TFE that are stacked in sequence. Although not illustrated, a functional layer may be further disposed between two adjacent layers of the base layer BS, the circuit layer DP-CL, the display element layer DP-EL, and the encapsulation layer TFE.

The base layer BS may provide a base surface on which the circuit layer DP-CL is disposed. The base layer BS may be a flexible substrate capable of being bent, folded, rolled, or the like. The base layer BS may be a glass substrate, a metal substrate, a polymer substrate, or the like. However, an embodiment is not limited thereto, and the base layer BS may be an inorganic layer, an organic layer, or a composite material layer in another embodiment.

The base layer BS may include a single layer or multiple layers. For example, the base layer BS may include a first synthetic resin layer, a multi-layered or single-layered inorganic layer, and a second synthetic resin layer disposed on the multi-layered or single-layered inorganic layer. Each of the first synthetic resin layer and the second synthetic resin layer may include a polyimide-based resin. Each of the first synthetic resin layer and the second synthetic resin layer may include at least one of an acrylic resin, a methacryl-based resin, a polyisoprene-based resin, a vinyl-based resin, an epoxy-based resin, a urethane-based resin, a cellulose-based resin, a siloxane-based resin, a polyamide-based resin, or a perylene-based resin. In the present disclosure, the “ . . . based” resin means including a functional group of “ . . . “.

The circuit layer DP-CL may be disposed on the base layer BS. The circuit layer DP-CL may include an insulation layer, a semiconductor pattern, a conductive pattern, a signal line, and/or the like. The display element layer DP-EL may be disposed on the circuit layer DP-CL. The display element layer DP-EL may include a light emitting element (not illustrated). For example, the light emitting element may include an organic light emitting material, an inorganic light emitting material, an organic-inorganic light emitting material, a quantum dot, a quantum rod, a micro LED, or a nano LED.

The encapsulation layer TFE may be disposed on the display element layer DP-EL. The encapsulation layer TFE may be disposed on the display element layer DP-EL. The encapsulation layer TFE may protect the display element layer DP-EL against moisture, oxygen, and a foreign matter such as dust particles. The encapsulation layer TFE may include at least one inorganic layer. For example, the encapsulation layer TFE may include an inorganic layer, an organic layer, and an inorganic layer that are stacked in sequence.

The input sensing layer ISP may be disposed on the display panel DP. The input sensing layer ISP may be disposed directly on the encapsulation layer TFE. Alternatively, an adhesive member may be disposed between the input sensing layer ISP and the display panel DP.

In the present disclosure, when one component is referred to as being disposed directly on another component, it means that a third component is not disposed between the one component and the other component. That is, one component being “disposed directly” on another component means that the one component is in “contact” with the other component.

The input sensing layer ISP may sense an external input to covert the external input into a predetermined input signal, and provide the input signal to the display panel DP. For example, the input sensing layer ISP may be a touch sensing layer that senses a touch. The input sensing layer ISP may perceive a direct touch by a user, an indirect touch by a user, a direct touch by an object, an indirect touch by an object, or the like.

The input sensing layer ISP may sense at least one of a position of a touch applied from the outside, or an intensity (pressure) of the touch. The input sensing layer ISP may have various structures, or be made of various materials, and is not limited to any one embodiment. For example, the input sensing layer ISP may sense an external input by using a capacitance method. The display panel DP may receive an input signal from the input sensing layer ISP, and generate an image corresponding to the input signal.

Referring to FIG. 5, the display panel DP may include pixels PX, a scan driver SDV, a data driver DDV, and an emission driver EDV.

The display panel DP may include a first area AA1, a second area AA2, and a bending area BA between the first area AA1 and the second area AA2. The bending area BA may extend in the first direction DR1, and the first area AA1, the bending area BA, and the second area AA2 may be arranged in the second direction DR2. The bending area BA may be bent around a bending axis extending in the first direction DR1 so that the second area AA2 overlaps a bottom surface of the first area AA1. According to an embodiment, a width of each of the bending area BA and the second area AA2 in the first direction DR1 may be less than a width of the first area AA1 in the first direction DR1. Accordingly, the bending area BA may be easily bent to the bottom surface of the first area AA1.

The first area AA1 may include a display area DA, and a non-display area NDA around the display area DA. The non-display area NDA may surround the display area DA. The display area DA may be an area that displays an image, and the non-display area NDA may be an area that does not display an image. Each of the second area AA2 and the bending area BA may be an area that does not display an image.

The first area NFA1 may include a first non-folding area NFA1, a second non-folding area NFA2, and a folding area FA between the first non-folding area NFA1 and the second non-folding area NFA2, which are arranged in the second direction DR2. The first and second non-folding areas NFA1 and NFA2 and the folding area FA may correspond to the first and second non-folding areas NFA1 and NFA2 and the folding area FA of the electronic apparatus ED, which are illustrated in FIG. 1A, respectively.

The first area AA1 may be bent to be folded around the folding axes described above. For example, the folding area FA of the first area AA1 may be folded around the folding axes described above so that the display panel DP is folded.

The display panel DP may include a plurality of pixels PX, a plurality of scan lines SLI to SLm, a plurality of data lines DL1 to DLn, a plurality of emission lines EL1 to ELm, first and second control lines CSL1 and CSL2, a power line PL, a plurality of connection lines CNL, and a plurality of pads PD. Here, m and n are each a natural number. The pixels PX may be disposed in the display area DA and connected to the scan lines SLI to SLm, the data lines DL1 to DLn, and the emission lines EL1 to Elm.

The scan driver SDV and the emission driver EDV may be disposed in the non-display area NDA. Each of the scan driver SDV and the emission driver EDV may be disposed in the non-display area NDA adjacent to each of opposite sides of the first area AA1, which are opposite to each other in the second direction DR2. The data driver DDV may be disposed in the second area AA2. The data driver DDV may be manufactured in the form of an integrated circuit chip to be mounted on the second area AA2.

The scan lines SLI to SLm may extend in the second direction DR2 to be connected to the scan driver SDV. The data lines DL1 to DLn may extend in the first direction DR1, and be connected to the data driver DDV via the bending area BA. The data driver DDV may be connected to the pixels PX through the data lines DL1 to DLn. The emission lines EL1 to ELm may extend in the second direction DR2 to be connected to the emission driver EDV.

The power line PL may extend in the first direction DR1 to be disposed in the non-display area NDA. The power line PL may be disposed between the display area DA and the emission driver EDV. The power line PL may extend to the second area AA2 via the bending area BA. The power line PL may extend toward a lower end of the second area AA2 in FIG. 5. The power line PL may receive a driving voltage.

The connection lines CNL may extend in the second direction DR2 and be arranged in the first direction DR1. The connection lines CNL may be connected to the power line PL and the pixels PX. The driving voltage may be applied to the pixels PX through the power line PL and the connection lines CNL, which are connected to each other.

A first control line CSL1 may be connected to the scan driver SDV and extend toward the lower end of the second area AA2 via the bending area BA in FIG. 5. A second control line CSL2 may be connected to the emission driver EDV and extend toward the lower end of the second area AA2 via the bending area BA in FIG. 5. The data driver DDV may be disposed between the first control line CSL1 and the second control line CSL2.

The pads PD may be disposed to be adjacent to the lower end of the second area AA2 in FIG. 5. The data driver DDV, the power line PL, the first control line CSL1, and the second control line CSL2 may be connected to the pads PD.

The data lines DL1 to DLn may be connected to corresponding pads PD, respectively, through the data driver DDV. For example, the data lines DL1 to DLn may be connected to the data driver DDV, and the data driver DDV may be connected to the pads PD corresponding to the data lines DL1 to DLn, respectively. Although not illustrated, a printed circuit board may be connected to the pads PD, and a timing controller and a voltage generator may be disposed on the printed circuit board. The timing controller may be manufactured as an integrated circuit chip to be mounted on the printed circuit board. The timing controller and the voltage generator may be connected to the pads PD through the printed circuit board.

The timing controller may control an operation of each of the scan driver SDV, the data driver DDV, and the emission driver EDV. The timing controller may generate a scan control signal, a data control signal, and an emission control signal in response to control signals received from the outside. The voltage generator may generate a driving voltage.

The scan control signal may be provided to the scan driver SDV through the first control line CSL1. The emission control signal may be provided to the emission driver EDV through the second control line CSL2. The data control signal may be provided to the data driver DDV. The timing controller may receive image signals from the outside, and convert a data format of the image signals to match an interface specification of the data driver DDV and provide the signals to the data driver DDV.

The scan driver SDV may generate a plurality of scan signals in response to the scan control signal. The scan signals may be applied to the pixels PX through the scan lines SLI to SLm. The scan signals may be sequentially applied to the pixels PX.

The data driver DDV may generate a plurality of data voltages corresponding to the image signals in response to the data control signal. The data voltages may be applied to the pixels PX through the data lines DL1 to DLn. The emission driver EDV may generate a plurality of emission signals in response to the emission control signal. The emission signals may be applied to the pixels PX through the emission lines EL1 to ELm.

The pixels PX may receive the data voltages in response to the scan signals. The pixels PX may display an image by emitting light with brightness corresponding to the data voltages in response to the emission signals. An emission time of the pixels PX may be controlled by the emission signals. Each of the pixels may include transistors, a capacitor, a light emitting element connected thereto. Each of the transistors may include a semiconductor pattern. The semiconductor pattern may include polysilicon, amorphous silicon, or a metal oxide. The semiconductor pattern may be doped with an n-type dopant or a p-type dopant. The semiconductor pattern may include a heavily doped region and a lightly doped region. The heavily doped region may have higher conductivity than the lightly doped region, and substantially serve as a source electrode and a drain electrode of the transistor. The lightly doped region may substantially correspond to an active (or channel) of the transistor.

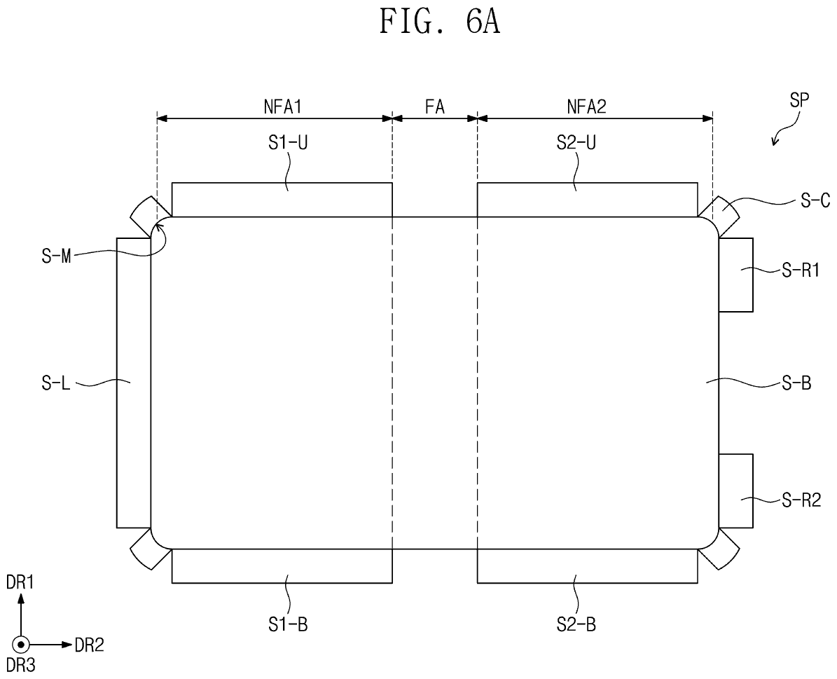

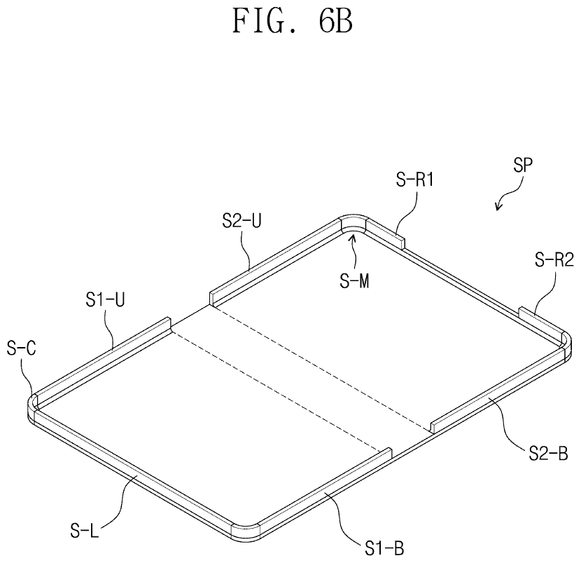

FIG. 6A is a development view of a support plate according to an embodiment. FIG. 6B is a perspective view of a support plate according to an embodiment. A support plate SP to be described with reference to FIGS. 6A and 6B is an embodiment of the support plate SP described with reference to FIG. 5. FIG. 6A illustrates the support plate SP in a state before coupling to the housing HAU (see FIG. 5), and FIG. 6B illustrates the support plate SP in a state of being coupled to the housing HAU (see FIG. 5).

Referring to FIGS. 6A and 6B, the support plate SP according to an embodiment may include a bottom portion S-B, which faces a lower portion of the housing HAU (see FIG. 3), and sidewall portions S1-U, S1-B, S2-U, S2-B, S-L, S-R1, S-R2 and S-C, each of which is bent from the bottom portion S-B. Each of the sidewall portions S1-U, S1-B, S2-U, S2-B, S-L, S-R1, S-R2 and S-C according to this embodiment may face a lateral portion of the housing HAU (see FIG. 5). The bottom portion S-B and the sidewall portions S1-U, S1-B, S2-U, S2-B, S-L, S-R1, S-R2 and S-C are substantially one component, but described as separate for convenience of explanation.

The bottom portion S-B may have a plate shape defined by the first direction DR1 and the second direction DR2. In this embodiment, each of corners S-M of the bottom portion S-B may have predetermined curvature and have a rounded shape.

A (1-1)-th sidewall portion S1-U may overlap a first non-folding area NFA1 of the bottom portion S-B in a plan view, and be disposed on a left upper end of the bottom portion S-B in FIG. 6A. The (1-1)-th sidewall portion S1-U may extend along a long side of the bottom portion S-B in the second direction DR2.

A (1-2)-th sidewall portion S1-B may overlap the first non-folding area NFA1 of the bottom portion S-B in a plan view, and be disposed on a left lower end of the bottom portion S-B in FIG. 6A. The (1-2)-th sidewall portion S1-B may extend along a long side of the bottom portion S-B in the second direction DR2. The (1-2)-th sidewall portion S1-B may be spaced apart from the (1-1)-th sidewall portion S1-U with the bottom portion S-B therebetween in the first direction DR1.

A (2-1)-th sidewall portion S2-U may overlap a second non-folding area NFA2 of the bottom portion S-B in a plan view, and be disposed on a right upper end of the bottom portion S-B in FIG. 6A. The (2-1)-th sidewall portion S2-U may extend along the long side of the bottom portion S-B in the second direction DR2. The (2-1)-th sidewall portion S2-U may be spaced apart from the (1-1)-th sidewall portion S1-U with a folding area FA therebetween in the second direction DR2.

A (2-2)-th sidewall portion S2-B may overlap the second non-folding area NFA2 of the bottom portion S-Bin a plan view, and be disposed on a right lower end of the bottom portion S-B in FIG. 6A. The (2-2)-th sidewall portion S2-B may extend along the long side of the bottom portion S-B in the second direction DR2.

The (2-2)-th sidewall portion S2-B may be spaced apart from the (2-1)-th sidewall portion S2-U with the bottom portion S-B therebetween in the first direction DR1. The (2-2)-th sidewall portion S2-B may be spaced apart from the (1-2)-th sidewall portion S1-B with the folding area FA therebetween in the second direction DR2.

A third sidewall portion S-L may overlap the first non-folding area NFA1 of the bottom portion S-B, and be disposed at a left side of the bottom portion S-B in a plan view. The third sidewall portion S-L may extend along a short side of the bottom portion S-B in the first direction DR1. According to an embodiment, a width of the third sidewall portion S-L in the first direction DR1 may be greater than a width of each of the sidewall portions S1-U, S1-B, S2-U and S2-B in the second direction DR2.

Fourth sidewall portions S-R1 and S-R2 may overlap the second non-folding area NFA2 of the bottom portion S-B, and be disposed at a right side of the bottom portion S-B in a plan view. The fourth sidewall portions S-R1 and S-R2 may include a (4-1)-th sidewall portion S-R1 and a (4-2)-th sidewall portion S-R2 that are spaced apart from each other in the first direction DR1. The bending area BA of the display panel DP described with reference to FIG. 5 may be disposed between the (4-1)-th sidewall portion S-R1 and the (4-2)-th sidewall portion S-R2.

According to an embodiment of the invention, even though the fourth sidewall portions S-R1 and S-R2 of the support plate SP are bent from the bottom portion S-B, as the (4-1)-th sidewall portion S-R1 and the (4-2)-th sidewall portion S-R2 that are spaced apart from each other are included, the bending area BA (see FIG. 5) of the display panel DP (see FIG. 5) may be easily bent to be accommodated in the housing HAU (see FIG. 3).

The support plate SP according to this embodiment may include fifth sidewall portions S-C. The fifth sidewall portions S-C may be disposed on the corners S-M of the bottom portion S-B, respectively. As the support plate SP includes the fifth sidewall portions S-C, the sidewall portions S1-U, S1-B, S2-U, S2-B, S-L, S-R1, S-R2 and S-C may be bent with predetermined curvature to be accommodated in the housing HAU (see FIG. 3).

As the sidewall portions S1-U, S1-B, S2-U, S2-B, S-L, S-R1, S-R2 and S-C are bent from the bottom portion S-B with predetermined curvature, stress on an area at which the support plate SP is bent may be reduced.

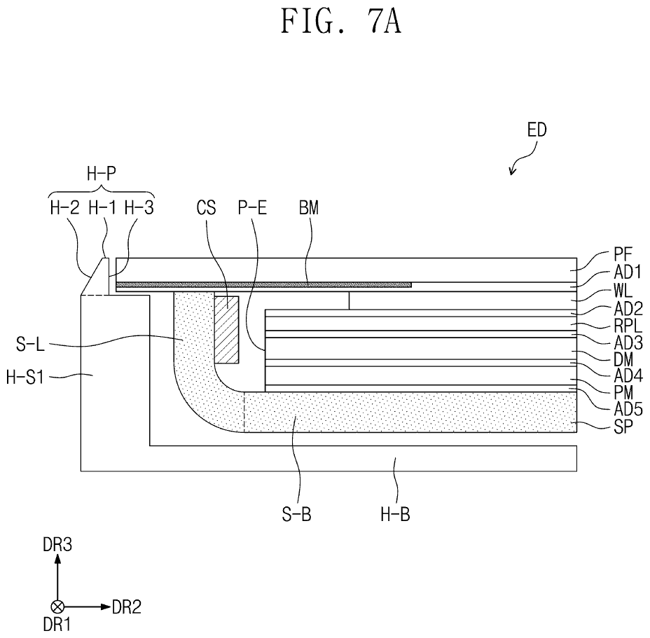

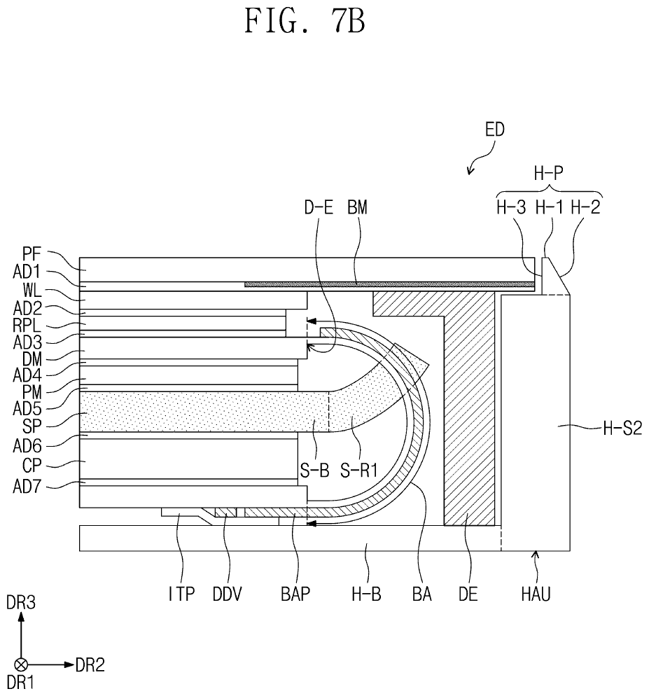

FIG. 7A is a cross-sectional view of one portion (e.g., the first non-folding area NFA1) of an electronic apparatus according to an embodiment. FIG. 7B is a cross-sectional view of another portion (e.g., the second non-folding area NFA2, the bending area BA, and the second area AA2) of an electronic apparatus according to an embodiment. FIGS. 7A and 7B are cross-sectional views cut by a plane defined by the second direction DR2 and the third direction DR3. The same/similar components as/to those described with reference to FIGS. 1A to 6B are designated by the same/similar reference numbers or symbols, and redundant contents will be omitted.

Referring to FIGS. 7A and 7B, an electronic apparatus ED according to an embodiment may include a protective layer PF, a window WL, a display module DM, an optical layer RPL, a lower film PM, a support plate SP, a support part DE, and a housing HAU.

The electronic apparatus ED may further include a printing layer BM. The printing layer BM may be provided on a bottom surface, which is in contact with a first adhesive layer AD1), of the protective layer PF. Alternatively, the printing layer BM may be provided on a top surface or a bottom surface of the window WL.

The printing layer BM may correspond to the first peripheral area F-NAA (see FIG. 1A). For example, a black pigment or a black dye may be provided to provide the printing layer BM.

A third sidewall portion S-L may be bent in a direction from a bottom portion S-B toward a first lateral portion H-S1 of the housing HAU. Thus, the third sidewall portion S-L may be disposed between the first lateral portion H-S1 of the housing HAU and a side surface P-E of the display module DM. The same as described with respect to the third sidewall portion S-L may apply to sidewall portions S1-U, S1-B, S2-U, S2-B and S-C. A portion, which faces the sidewall portions S1-U, S1-B, S2-U, S2-B and S-L, of the housing HAU may be defined as the first lateral portion H-S1, and a portion, which faces the other sidewall portions S-R1 and S-R2, of the housing HAU may be defined as a second lateral portion H-S2.

The electronic apparatus ED may further include a cushion layer CS. In this embodiment, the cushion layer CS may be disposed between the side surface P-E of the display module DM and each of the sidewall portions S1-U, S1-B, S2-U, S2-B, S-L and S-C. The cushion layer CS may be in contact with the sidewall portions S1-U, S1-B, S2-U, S2-B, S-L and S-C.

The cushion layer CS may include an elastomer such as sponge, foam, or a urethane resin. The cushion layer CS may include at least one of an acrylic polymer, a urethane-based polymer, a silicon-based polymer, or an imide-based polymer.

As illustrated in FIG. 7B, in a state of being bent, a bending area BA of the display panel DP (see FIG. 5) may be accommodated in the housing HAU. In the display module DM according to an embodiment of the invention, a stepped portion D-E may be provided on each of a start point at which curvature starts, and an end point at which the curvature ends, in order to easily perform the bending of the bending area BA. Thus, a thickness of the bending area BA of the display module DM may be less than a thickness of the display module DM adjacent to the bending area BA. Accordingly, a neutral plane of the bending area BA may be maintained, and stress applied to conductive patterns disposed on the bending area BA may be minimized.

The bending area BA may be disposed in an inner space which a (4-1)-th sidewall portion S-R1 and a (4-2)-th sidewall portion S-R2 are spaced from each other in the first direction DR1. Accordingly, even though the sidewall portions S1-U, S1-B, S2-U, S2-B, S-L, S-C, S-R1 and S-R2 of the support plate SP are bent, an interference between the bending area BA and the support plate SP may be minimized.

The electronic apparatus ED according to an embodiment may further include a panel protection layer CP. The panel protection layer CP may be disposed at a lower portion of the support plate SP, which is adjacent to the bending area BA. The panel protection layer CP may maintain the curvature of the bending area BA to be constant, and may compensate a height difference with a portion, which is disposed at the lower portion of the support plate SP due to the bending area BA, of the display module DM. The panel protection layer CP may protect a lower portion of the display module DM. The panel protection layer CP may include a flexible plastic material. For example, the panel protection layer CP may include a polyethylene terephthalate (“PET”).

The panel protection layer CP may be coupled to the support plate SP through a sixth adhesive layer AD6, and coupled to the portion disposed at the lower portion of the support plate SP through a seventh adhesive layer AD7.

The electronic apparatus ED according to an embodiment may further include a bending protection layer BAP that covers the bending area BA. The bending protection layer BAP according to an embodiment may continuously extend from a portion of a first area AA1 which is adjacent to the bending area BA, through the bending area BA, to a portion of a second area AA2 which is adjacent to the bending area BA. The bending protection layer BAP may be spaced apart from the data driver DDV. The bending protection layer BAP may include an acrylic resin or a urethane-based resin.

The electronic apparatus ED according to an embodiment may further include an insulation tape ITP that covers the data driver DDV. The insulation tape ITP may cover a portion of the bending protection layer BAP. The insulation tape ITP is not limited to any one as long as including an insulation material.

The support part DE may be disposed between the bending area BA and the second lateral portion H-S2 of the housing HAU. In this embodiment, the support part DE may include a first portion extending in the third direction DR3, and a second portion protruding from the first portion and extending in the second direction DR2. The first portion and the second portion may be perpendicular to each other. The bending area BA may be disposed between the first portion and the second portion so that the bending area BA is protected.

The housing HAU according to this embodiment may include a lower portion H-B, lateral portions H-S1 and H-S2 each extending from the lower portion H-B in the third direction DR3, and a protruding portion H-P protruding from each of the lateral portions H-S1 and H-S2.

The protruding portion H-P according to an embodiment may include a first surface H-1 that faces a top surface of each of the lateral portions H-S1 and H-S2, a second surface H-2 that connects the first surface H-1 to an outer surface of each of the lateral portions H-S1 and H-S2, and a third surface H-3 that connects the first surface H-1 to the top surface of each of the lateral portions H-S1 and H-S2.

In this embodiment, the first surface H-1 may extend in the second direction DR2 to be parallel to the top surface of each of the lateral portions H-S1 and H-S2. According to an embodiment, an angle between the first surface H-1 and the second surface H-2 may be an obtuse angle, and an angle between the first surface H-1 and the third surface H-3 may be a right angle.

In this embodiment, a portion of the protective layer PF may be disposed on a portion, which is exposed from the protruding portion H-P, of the top surface of each of the lateral portions H-S1 and H-S2. Accordingly, when the electronic apparatus ED is folded, the protective layer PF may be prevented from slipping to the outside of the housing HAU. A portion of the printing layer BM may be disposed on each of the lateral portions H-S1 and H-S2.

According to an embodiment of the invention, as the support plate SP includes the sidewall portions S1-U, S1-B, S2-U, S2-B, S-L, S-R1, S-R2 and S-C, the support part DE may not be disposed in an area except an area adjacent to the bending area BA. That is, the support plate SP may replace the existing function of the support part DE by using the sidewall portions S1-U, S1-B, S2-U, S2-B, S-L, S-R1, S-R2 and S-C.

Accordingly, a space for disposing a separate support part may be reduced to decrease a distance from the outer surface of the housing HAU to the display area DA (see FIG. 5) of the display panel DP (see FIG. 5). Thus, the first peripheral area F-NAA (see FIG. 1A) of the electronic apparatus ED may be effectively reduced. According to an embodiment of the invention, the distance from the outer surface of the housing HAU to the display area DA (see FIG. 5) of the display panel DP (see FIG. 5) may be less than about 4.2 millimeters (mm).

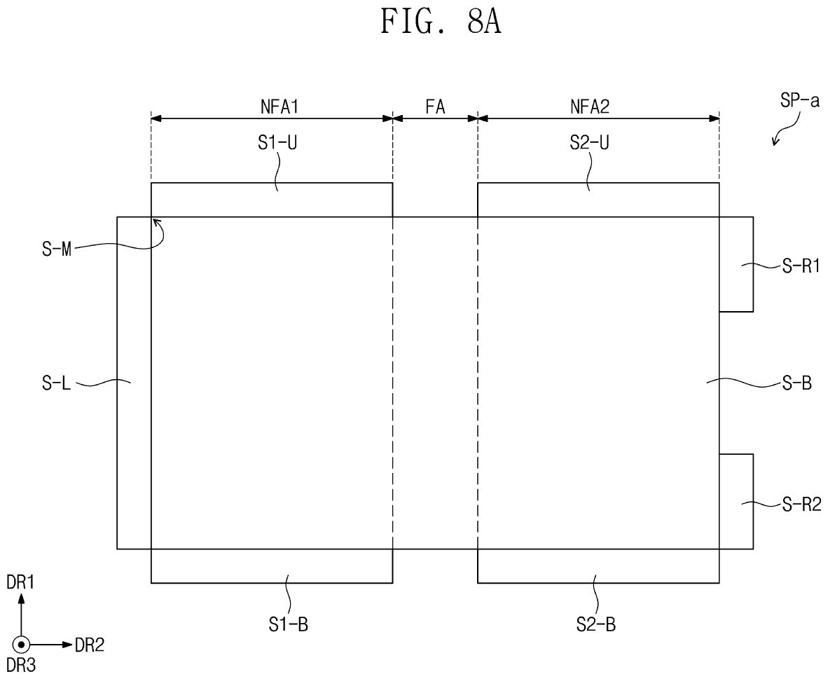

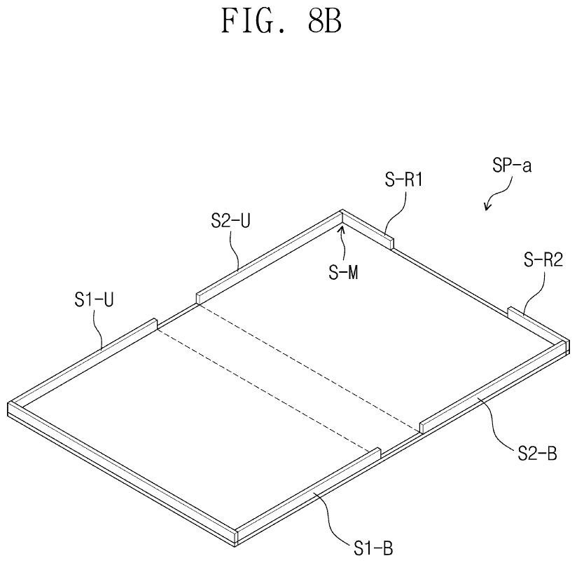

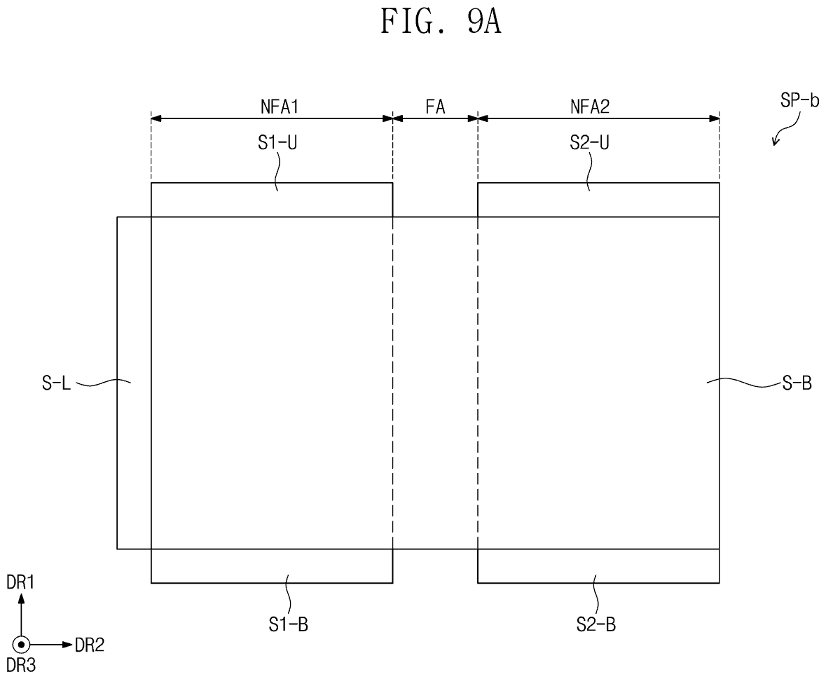

FIG. 8A is a plan view of a support plate according to an embodiment. FIG. 8B is a perspective view of a support plate according to an embodiment. FIG. 9A is a plan view of a support plate according to an embodiment. FIG. 9B is a perspective view of a support plate according to an embodiment. Support plates SP-a and SP-b to be described with reference to FIGS. 8A to 9B are other embodiments of the support plate SP described with reference to FIG. 5.

FIGS. 8A and 9A illustrate the support plates SP-a and SP-b each being in a state before coupling to the housing HAU (see FIG. 5), and FIGS. 8B and 9B illustrate the support plates SP-a and SP-b each being in a state of being coupled to the housing HAU (see FIG. 5).

Referring to FIGS. 8A and 8B, the support plate SP-a according to an embodiment may include a bottom portion S-B, which faces a lower portion of the housing HAU (see FIG. 5), and sidewall portions SS1-U, S1-B, S2-U, S2-B, S-L, S-R1 and S-R2, each of which is bent from the bottom portion S-B. Each of the sidewall portions S1-U, S1-B, S2-U, S2-B, S-L, S-R1 and S-R2 according to this embodiment may face a lateral portion of the housing HAU (see FIG. 5). The bottom portion S-B and the sidewall portions S1-U, S1-B, S2-U, S2-B, S-L, S-R1 and S-R2 are substantially one component, but described as separate for convenience of explanation.

The bottom portion S-B may have a plate shape defined by the first direction DR1 and the second direction DR2. In this embodiment, each of corners S-M of the bottom portion S-B may be perpendicular.

A (1-1)-th sidewall portion S1-U may overlap a first non-folding area NFA1 of the bottom portion S-B in a plan view, and be disposed on a left upper end of the bottom portion S-B in FIG. 6A. The (1-1)-th sidewall portion S1-U may extend along a long side of the bottom portion S-B in the second direction DR2.

A (1-2)-th sidewall portion S1-B may overlap the first non-folding area NFA1 of the bottom portion S-B in a plan view, and be disposed on a left lower end of the bottom portion S-B in FIG. 6A. The (1-2)-th sidewall portion S1-B may extend along a long side of the bottom portion S-B in the second direction DR2. The (1-2)-th sidewall portion S1-B may be spaced apart from the (1-1)-th sidewall portion S1-U with the bottom portion S-B therebetween in the first direction DR1.

A (2-1)-th sidewall portion S2-U may overlap a second non-folding area NFA2 of the bottom portion S-B in a plan view, and be disposed on a right upper end of the bottom portion S-B in FIG. 6A. The (2-1)-th sidewall portion S2-U may extend along the long side of the bottom portion S-B in the second direction DR2. The (2-1)-th sidewall portion S2-U may be spaced apart from the (1-1)-th sidewall portion S1-U with a folding area FA therebetween in the second direction DR2.

A (2-2)-th sidewall portion S2-B may overlap the second non-folding area NFA2 of the bottom portion S-B in a plan view, and be disposed on a right lower end of the bottom portion S-B in FIG. 6A. The (2-2)-th sidewall portion S2-B may extend along the long side of the bottom portion S-B in the second direction DR2. The (2-2)-th sidewall portion S2-B may be spaced apart from the (2-1)-th sidewall portion S2-U with the bottom portion S-B therebetween in the first direction DR1. The (2-2)-th sidewall portion S2-B may be spaced apart from the (1-2)-th sidewall portion S1-B with the folding area FA therebetween in the second direction DR2.

A third sidewall portion S-L may overlap the first non-folding area NFA1 of the bottom portion S-B, and be disposed at a left side of the bottom portion S-B in a plan view. The third sidewall portion S-L may extend along a short side of the bottom portion S-B in the first direction DR1. According to an embodiment, a width of the third sidewall portion S-L in the first direction DR1 may be greater than a width of each of the sidewall portions S1-U, S1-B, S2-U and S2-B in the second direction DR2.

Fourth sidewall portions S-R1 and S-R2 may overlap the second non-folding area NFA2 of the bottom portion S-B, and be disposed at a right side of the bottom portion S-B in a plan view. The fourth sidewall portions S-R1 and S-R2 may include a (4-1)-th sidewall portion S-R1 and a (4-2)-th sidewall portion S-R2 that are spaced apart from each other in the first direction DR1. The bending area BA of the display panel DP described with reference to FIG. 5 may be disposed between the (4-1)-th sidewall portion S-R1 and the (4-2)-th sidewall portion S-R2.

According to an embodiment of the invention, even though the fourth sidewall portions S-R1 and S-R2 of the support plate SP are bent from the bottom portion S-B, as the (4-1)-th sidewall portion S-R1 and the (4-2)-th sidewall portion S-R2 that are spaced apart from each other are included, the bending area BA (see FIG. 5) of the display panel DP (see FIG. 5) may be easily bent to be accommodated in the housing HAU (see FIG. 3).

As each of corners S-M of the bottom portion S-B has a perpendicular shape as illustrated in FIG. 8B, respective side surfaces of adjacent sidewall portions of the sidewall portions S1-U, S1-B, S2-U, S2-B, S-L, S-R1 and S-R2 may be in contact with each other when being accommodated in the housing HAU (see FIG. 3).

According to this embodiment, an angle between the bottom portion S-B and each of the sidewall portions S1-U, S1-B, S2-U, S2-B, S-L, S-R1 and S-R2 may be vertical. Accordingly, a distance from the housing HAU (see FIG. 3) to each of the sidewall portions S1-U, S1-B, S2-U, S2-B, S-L, S-R1 and S-R2 may be decreased.

The support plate SP-b to be described with reference to FIGS. 9A and 9B will be mainly described in terms of differences with the support plate SP-a described with reference to FIGS. 8A and 8B.

Referring to FIGS. 9A and 9B, the support plate SP-b according to an embodiment may include a bottom portion S-B, which faces a lower portion of the housing HAU (see FIG. 5), and sidewall portions S1-U, S1-B, S2-U, S2-B and S-L, each of which is bent from the bottom portion S-B. Each of the sidewall portions S1-U, S1-B, S2-U, S2-B and S-L according to this embodiment may face a lateral portion of the housing HAU (see FIG. 5). The bottom portion S-B and the sidewall portions S1-U, S1-B, S2-U, S2-B and S-L are substantially one component, but described as separate for convenience of explanation.

Unlike the support plate SP-a described with reference to FIGS. 8A and 8B, the support plate SP-b according to this embodiment may not include fourth sidewall portions S-R1 and S-R2. Thus, even when the width of the bending area BA (see FIG. 5) of the display panel DP (see FIG. 5) in the first direction DR1 is increased, the bending area BA (see FIG. 5) of the display panel DP (see FIG. 5) may be easily bent to a lower portion of the support plate SP-b.

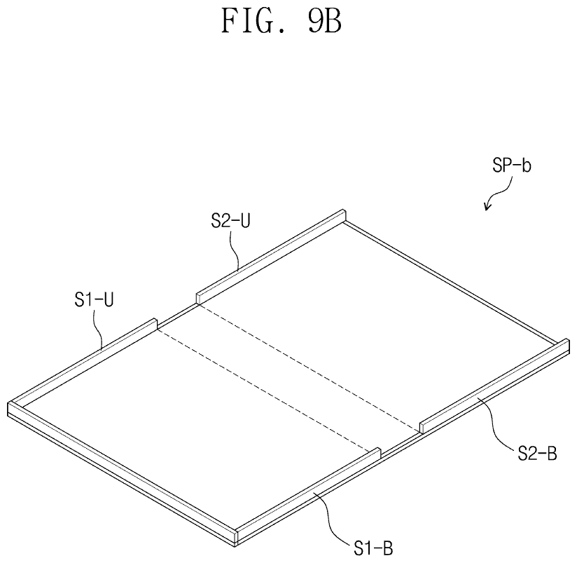

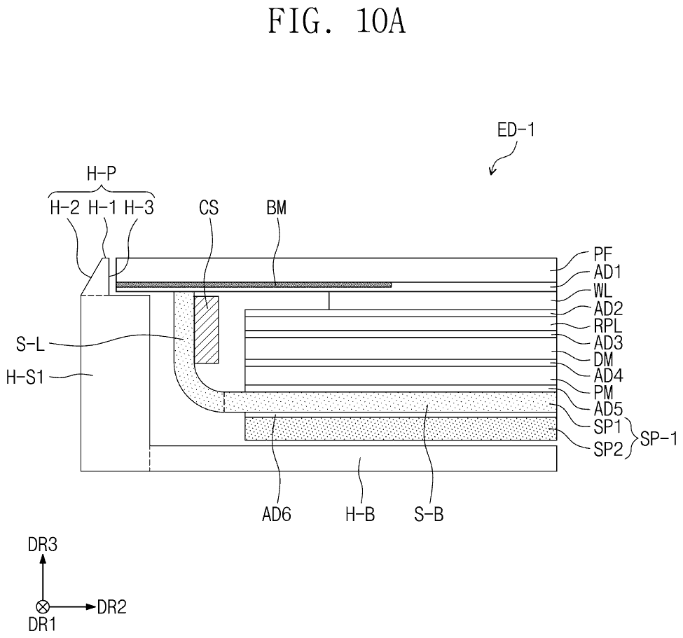

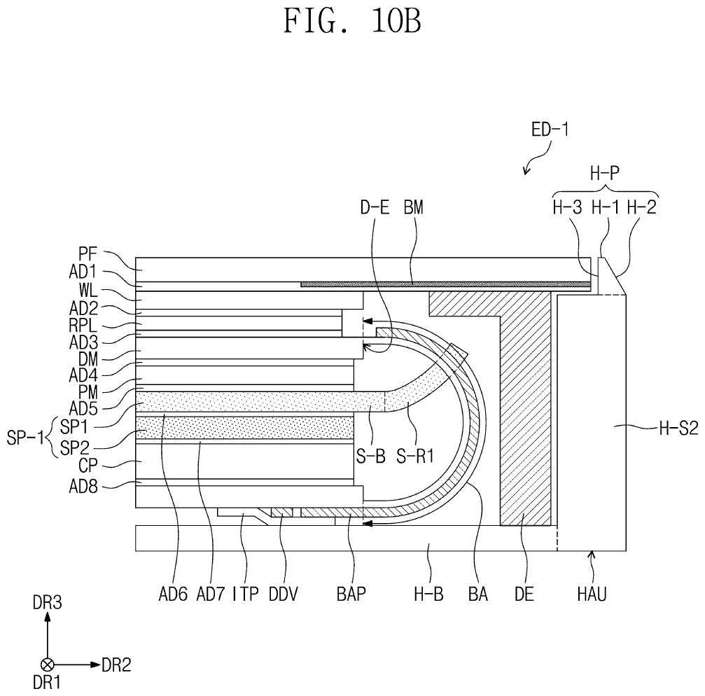

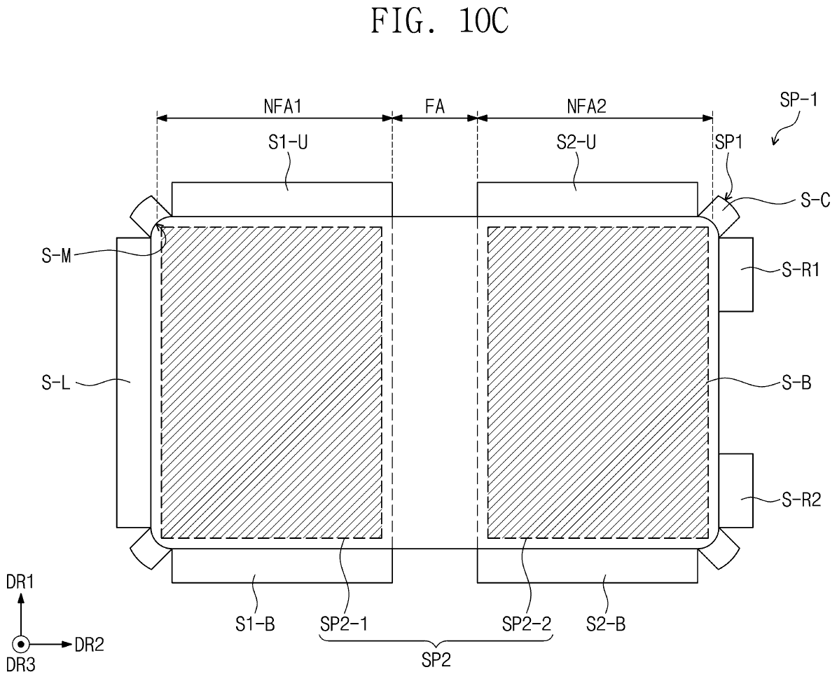

FIG. 10A is a cross-sectional view of one portion of an electronic apparatus according to an embodiment. FIG. 10B is a cross-sectional view of another portion of an electronic apparatus according to an embodiment. FIG. 10C is a plan view of plates according to an embodiment. Differences with the electronic apparatus ED described with reference to FIGS. 7A and 7B will be mainly described.

Referring to FIGS. 10A and 10B, an electronic apparatus ED-1 according to an embodiment may include a protective layer PF, a window WL, a display module DM, an optical layer RPL, a lower film PM, a plate SP-1, a support part DE, and a housing HAU. The electronic apparatus ED-1 may further include a cushion layer CS, a panel protection layer CP, and a printing layer BM.

The electronic apparatus ED-1 may include adhesive layers AD1 to AD8, each of which is disposed between components. Each of the adhesive layers AD1 to AD7 may include a common adhesive such as pressure sensitive adhesive (PSA), optically clear adhesive (OCA), or optical clear resin (OCR), and is not limited to any one embodiment.

The plate SP-1 according to this embodiment may include a support plate SP1, and a lower plate SP2 disposed below the support plate SP1.

As illustrated in FIG. 10C, the support plate SP1 may correspond to the support plate SP described with reference to FIG. 6A. Thus, the support plate SP1 may include a matrix including a filler, and fiber lines which are disposed inside the matrix and have a woven shape. The fiber lines may be disposed in a fabric shape inside the matrix.

The support plate SP1 may include a bottom portion S-B, which faces a lower portion of the housing HAU (see FIG. 5), and sidewall portions S1-U, S1-B, S2-U, S2-B, S-L, S-R1, S-R2 and S-C, each of which is bent from the bottom portion S-B.

The lower plate SP2 may be coupled to the support plate SP1 through a seventh adhesive layer AD7, and coupled to a portion of the display module DM through an eighth adhesive layer AD8. In this embodiment, the lower plate SP2 may include a different material from the support plate SP1. The lower plate SP2 may include a material having higher rigidity than a material of the support plate SP1. For example, the support plate SP1 may include at least one of stainless steel or aluminum. However, an embodiment of the invention is not limited thereto. For another example, the lower plate SP2 may be bonded to the support plate SP1 by thermal fusion, and here, the seventh adhesive layer AD7 may be omitted.

In this embodiment, a sum of a thickness of the support plate SP1 (e.g., the bottom portion S-B) and a thickness of the lower plate SP2 may be about 50 μm to about 250 μm.

Referring to FIG. 10C, the lower plate SP2 may include a first plate SP2-1 overlapping a first non-folding area NFA1, and a second plate SP2-2 overlapping a second non-folding area NFA2. The first plate SP2-1 and the second plate SP2-2 may be spaced apart from each other with a folding area FA therebetween.

In the plate SP-1 according to this embodiment, the lower plate SP2 having relatively high rigidity may be disposed below the support plate SP1 to supplement rigidity of the plate SP-1. In addition, as the first plate SP2-1 and the second plate SP2-2 are spaced apart from each other with the folding area FA therebetween, a folding operation of the electronic apparatus ED-1 may be more easily performed.

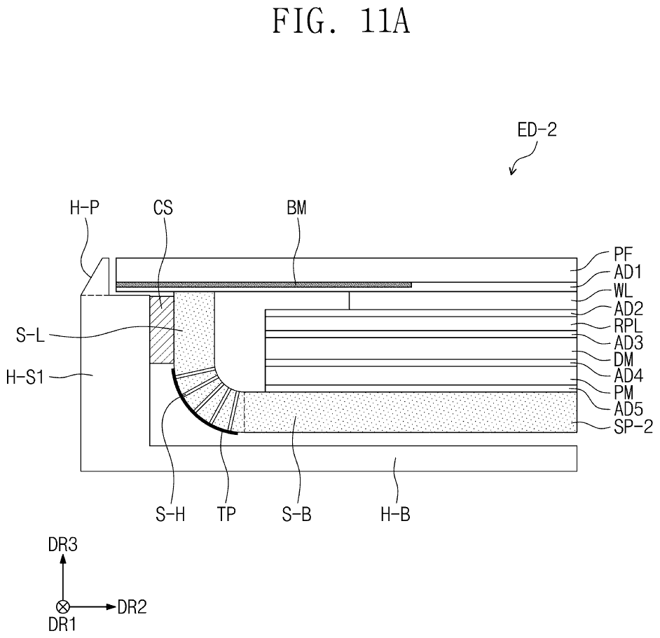

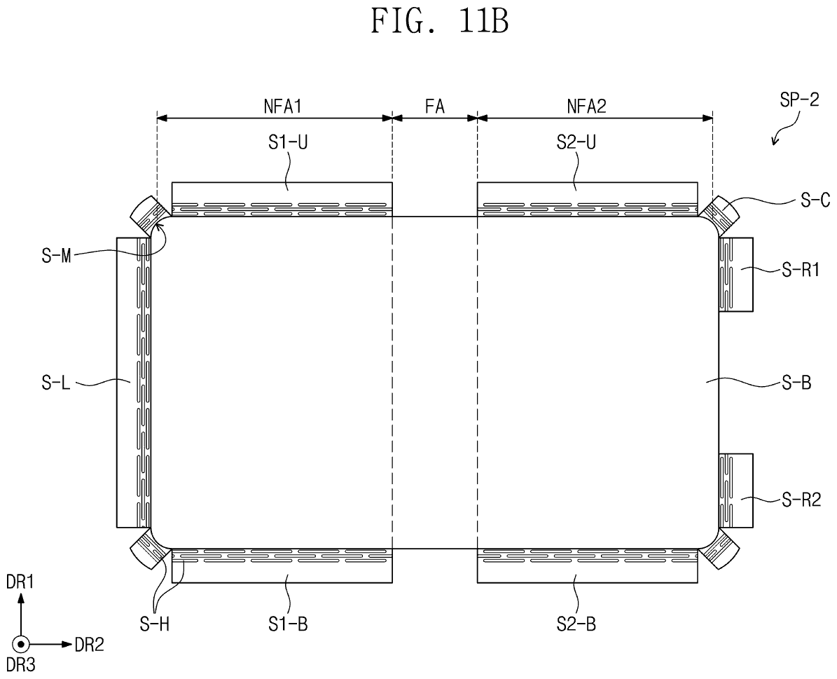

FIG. 11A is a cross-sectional view of one portion of an electronic apparatus according to an embodiment. FIG. 11B is a development view of a support plate according to an embodiment. Differences with the electronic apparatus ED described with reference to FIGS. 7A and 7B will be mainly described.

Referring to FIGS. 11A and 11B, an electronic apparatus ED-2 according to an embodiment may include a protective layer PF, a window WL, a display module DM, an optical layer RPL, a lower film PM, a support plate SP-2, and a housing HAU. The electronic apparatus ED-2 may further include a cushion layer CS and a printing layer BM.

The electronic apparatus ED-2 may include adhesive layers AD1 to AD5, each of which is disposed between components. Each of the adhesive layers AD1 to AD5 may include a common adhesive such as pressure sensitive adhesive (PSA), optically clear adhesive (OCA), or optical clear resin (OCR), and is not limited to any one embodiment.

A plurality of holes S-H may be defined to pass through each of sidewall portions S1-U, S1-B, S2-U, S2-B, S-L, S-R1, S-R2 and S-C of the support plate SP-2 according to this embodiment. The holes defined in each of the sidewall portions S1-U, S1-B, S2-U, S2-B, S-L, S-R1, S-R2 and S-C may be provided to be adjacent to a boundary of a bottom portion S-B. The holes S-H may extend to the same direction as extending direction the boundary of the bottom portion S-B. As each of the sidewall portions S1-U, S1-B, S2-U, S2-B, S-L, S-R1, S-R2 and S-C includes the holes S-H, the sidewall portions S1-U, S1-B, S2-U, S2-B, S-L, S-R1, S-R2 and S-C may be easily bent when being accommodated in the housing HAU.

The electronic apparatus ED-2 according to an embodiment may further include a cover tape TP. The cover tape TP may be disposed on the outside of the sidewall portions S1-U, S1-B, S2-U, S2-B, S-L, S-R1, S-R2 and S-C adjacent to the housing HAU so as to cover the holes S-H. The cover tape TP may prevent foreign matters or the like from being introduced into the holes S-H.

According to this embodiment, the cushion layer CS may be disposed between a lateral portion H-S1 of the housing HAU and each of the sidewall portions S1-U, S1-B, S2-U, S2-B, S-L, S-R1, S-R2 and S-C. As each of the sidewall portions S1-U, S1-B, S2-U, S2-B, S-L, S-R1, S-R2 and S-C includes the holes, the sidewall portions S1-U, S1-B, S2-U, S2-B, S-L, a shape thereof may be changed when the electronic apparatus ED-2 is folded. Here, the cushion layer CS may absorb an impact between each of the sidewall portions S1-U, S1-B, S2-U, S2-B, S-L, S-R1, S-R2 and S-C and the housing HAU.

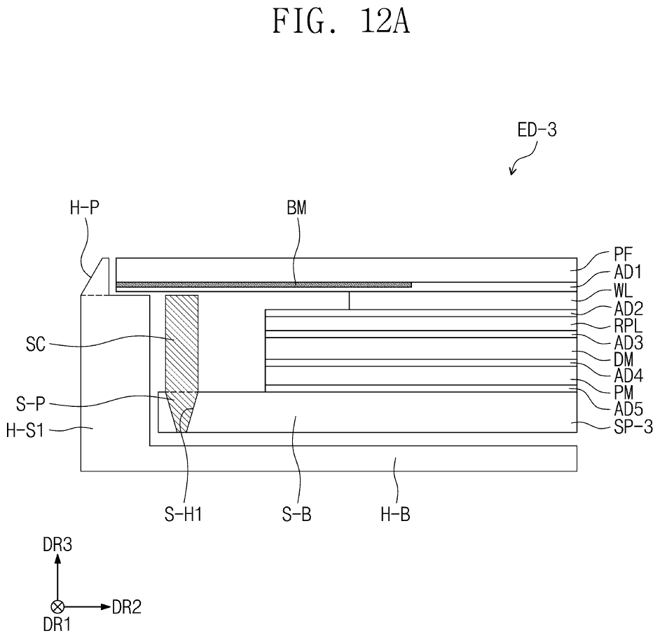

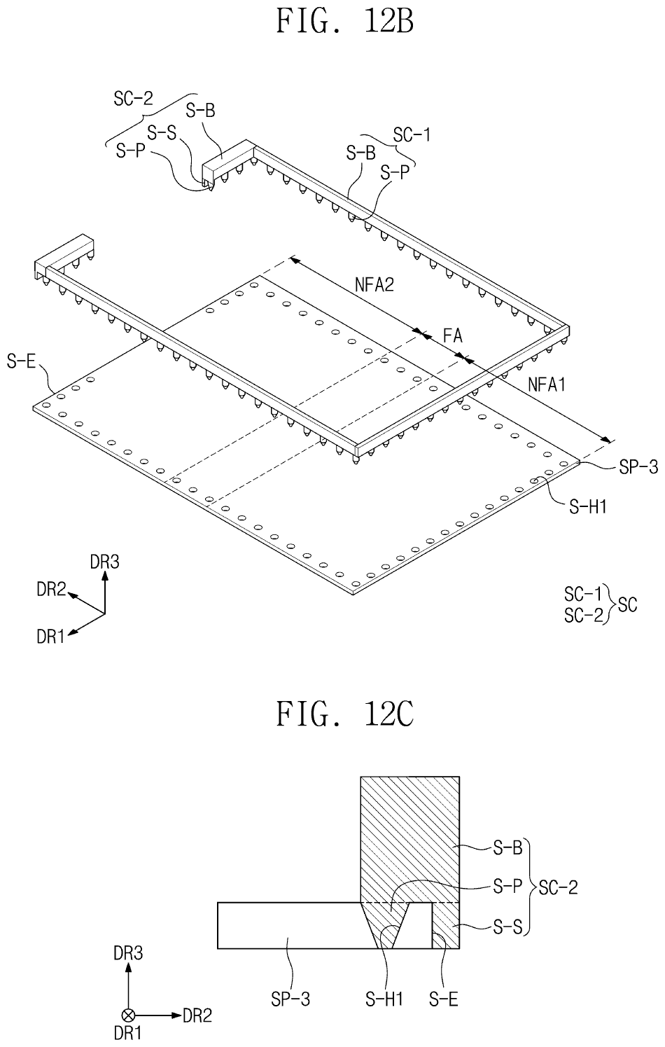

FIG. 12A is a cross-sectional view of one portion of an electronic apparatus according to an embodiment. FIG. 12B is a perspective view of a support plate and a coupling part according to an embodiment. FIG. 12C is a perspective view of a state in which a support plate and a coupling part are coupled to each other according to an embodiment. Differences with the electronic apparatus ED described with reference to FIGS. 7A and 7B will be mainly described.

Referring to FIGS. 12A and 12B, an electronic apparatus ED-3 according to an embodiment may include a protective layer PF, a window WL, a display module DM, an optical layer RPL, a lower film PM, a support plate SP-3, and a housing HAU. The electronic apparatus ED-3 may further include a cushion layer CS and a printing layer BM. The electronic apparatus ED may further include a printing layer BM.

The electronic apparatus ED-3 according to this embodiment may further include a coupling part SC coupled to the support plate SP-3 compared to the previous embodiments.

Referring to FIG. 12B, in this embodiment, the support plate SP-3 may have a rectangular shape extending in the first direction DR1 and the second direction DR2. A plurality of holes S-H1, which are arranged along edges of the support plate SP-3 and through which the support plate SP-3 are passed, may be defined in the support plate SP-3. The coupling part SC may be inserted and coupled to the holes S-H1.

The coupling part SC may extend along the edges of the support plate SP-3. The coupling part SC may include a main coupling part SC-1 and sub-coupling parts SC-2. The sub-coupling parts SC-2 may be disposed in a second non-folding area NFA2, and be disposed to be spaced apart from each other in the first direction DR1. The bending area BA of the display panel DP (see FIG. 5) may be disposed between the sub-coupling parts SC-2.

The main coupling part SC-1 may include a body S-B and protrusion portions S-P. The body S-B may extend along the edges of the support plate SP-3. The protrusion portions S-P may protrude from the body S-B in the direction opposite to the third direction DR3. The protrusion portions S-P may be coupled into the holes S-H1 corresponding thereto to stably fix the body S-B onto the support plate SP-3.

Referring to FIG. 12C, the sub-coupling parts SC-2 may include a body S-B, protrusion portions S-P, and additional support portion S-S. Each of the sub-coupling parts SC-2 may have a smaller width in the first direction DR1 than the main coupling part SC-1, and thus coupling force between the sub-coupling part SC-2 and the support plate SP-3 may be weak. Thus, the additional support portion S-S that is in contact with a side surface S-E of the support plate SP-3 may be further included. The additional support portion S-S may protrude from the body S-B in the direction opposite to the third direction DR3. The coupling part SC may be formed through an insert injection process.

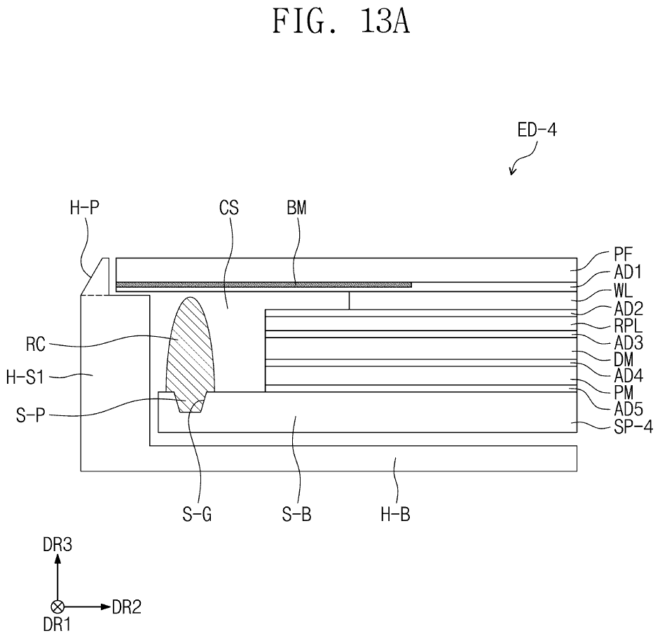

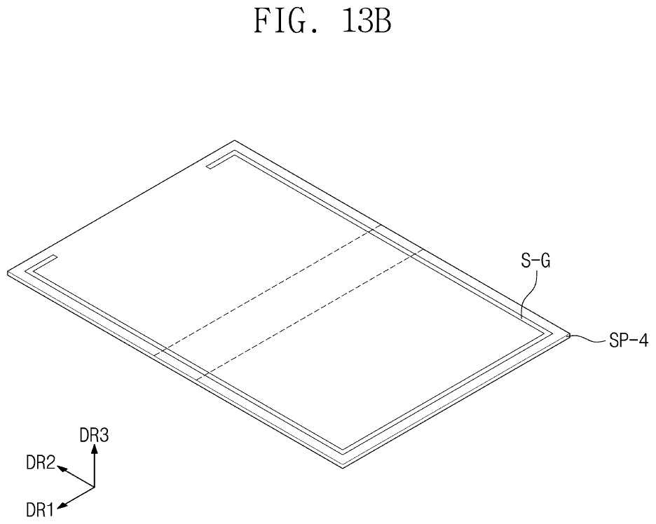

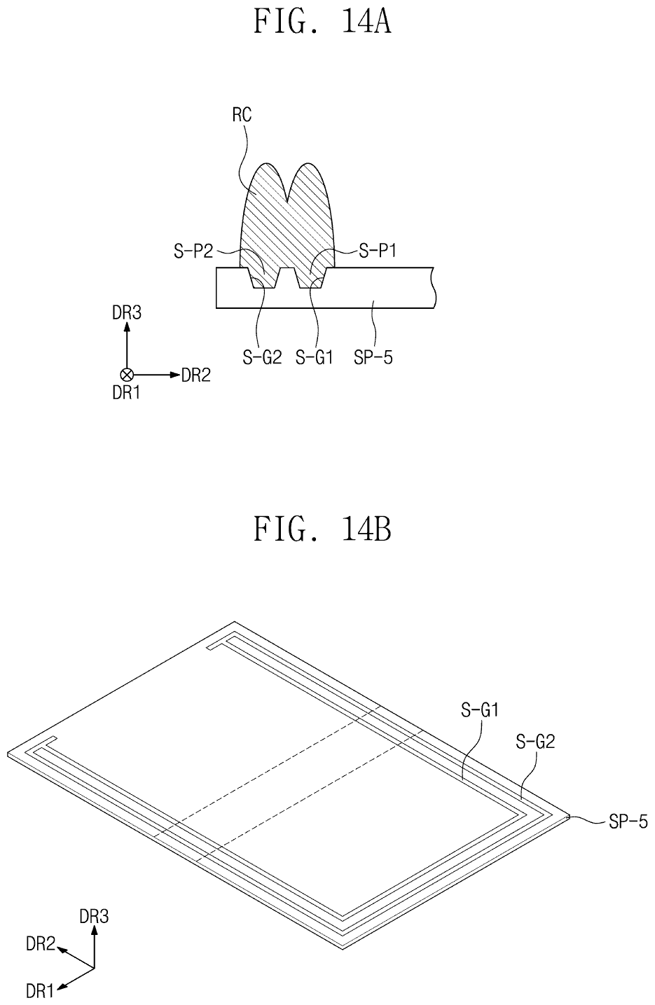

FIG. 13A is a cross-sectional view of one portion of an electronic apparatus according to an embodiment. FIG. 13B is a perspective view of a support plate according to an embodiment. FIG. 14A is a cross-sectional view of a state in which a support plate and a coupling part are coupled to each other according to an embodiment. FIG. 14B is a perspective view of a support plate according to an embodiment. Differences with the electronic apparatus ED described with reference to FIGS. 7A and 7B will be mainly described.

Referring to FIGS. 13A and 13B, an electronic apparatus ED-4 according to an embodiment may include a protective layer PF, a window WL, a display module DM, an optical layer RPL, a lower film PM, a support plate SP-4, and a housing HAU. The electronic apparatus ED-4 may further include a cushion layer CS and a printing layer BM.

The electronic apparatus ED-4 according to this embodiment may further include a coupling part RC coupled to the support plate SP-4.

Referring to FIG. 13B, in this embodiment, the support plate SP-4 may have a rectangular shape extending in the first direction DR1 and the second direction DR2. A groove S-G, which extends along edges of the support plate SP-4 and corresponds to a portion removed in a direction from a top surface toward a bottom surface of the support plate SP-4, may be defined in the support plate SP-4.

A protrusion portion S-P of the coupling part RC may be inserted and coupled to the groove S-P. The protrusion portion S-P of the coupling part RC may have the same shape as the groove S-P.

The coupling part RC according to this embodiment may include a resin. Thus, the resin may be applied along a shape of the groove S-G, and then a process of curing the resin may be repeated to form the coupling part RC. The coupling part RC may protrude in the third direction DR3 to have a convex shape.

FIG. 13A illustrates the groove S-G recessed in a portion of the support plate SP-4, but an embodiment of the invention is not limited thereto. For another example, the groove S-P may pass through the entirety of the support plate SP-4, and is not limited to any one embodiment.

Referring to FIGS. 14A and 14B, grooves S-G1 and S-G2, each of which extends along edges of a support plate SP-5 according to an embodiment and corresponds to a portion removed in a direction from a top surface toward a bottom surface of the support plate SP-5, may be defined in the support plate SP-5. A protrusion portions S-P1 and S-P2 of a coupling part RC may be inserted and coupled to the grooves S-G1 and S-G2, respectively. The protrusion portions S-P1 and S-P2 of the coupling part RC may have the same shapes as the grooves S-P1 and S-P2, respectively. FIG. 14A illustrates only one side of the support plate SP-5.

As illustrated in FIG. 14B, the grooves S-G1 and S-G2 may include a first groove S-G1, which is defined to be relatively adjacent to a center of the support plate SP-5, and a second groove S-G2 which is disposed to be more outward from the center of the support plate SP-5 than the first groove S-G1 is, and surrounds the first groove S-G1.

A resin may be applied along a shape of each of the first groove S-G1 and the second groove S-G2, and then a process of curing the resin may be repeated to form the coupling part RC. The coupling part RC may protrude in the third direction DR3 to have a double-humped shape.

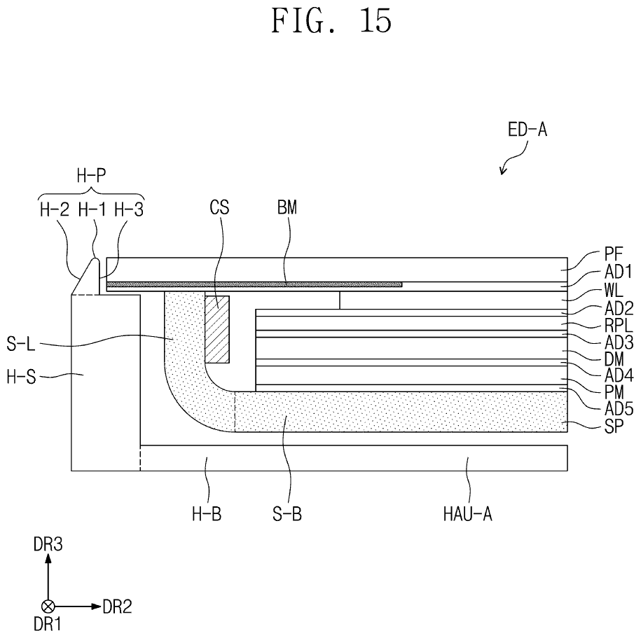

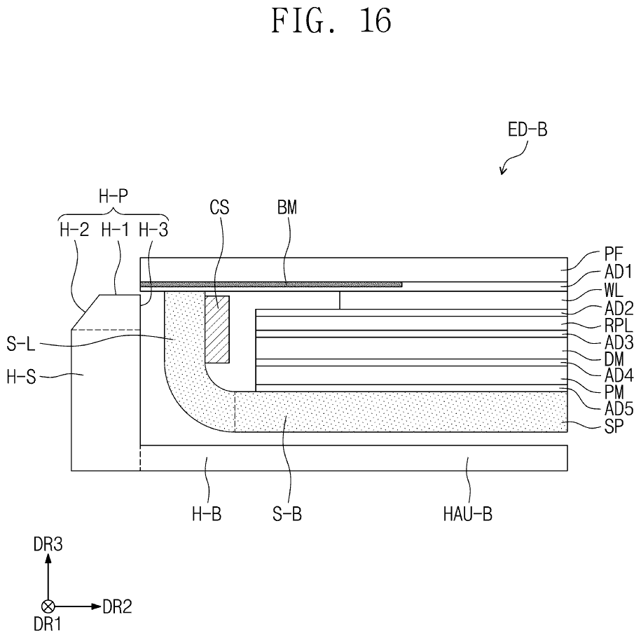

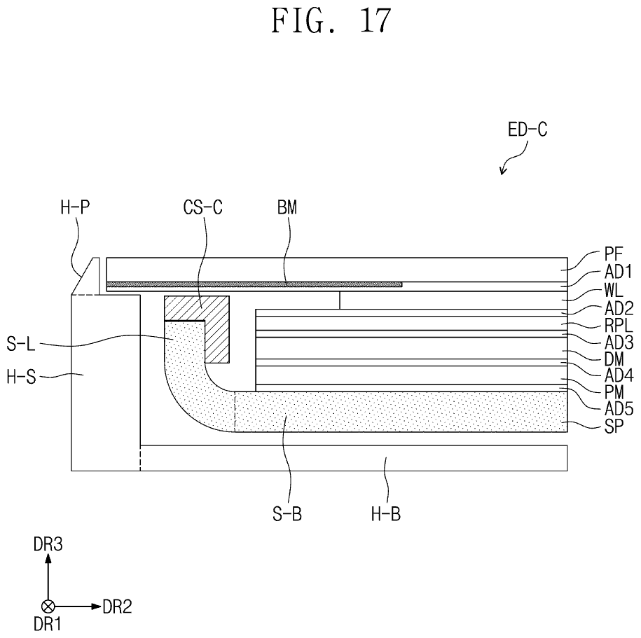

FIG. 15A is a cross-sectional view of one portion of an electronic apparatus according to an embodiment. FIG. 16 is a cross-sectional view of one portion of an electronic apparatus according to an embodiment. FIG. 17 is a cross-sectional view of one portion of an electronic apparatus according to an embodiment.

The same/similar components as/to those described with reference to FIG. 7A are designated by the same/similar reference numbers or symbols, and redundant contents will be omitted. Differences with the electronic apparatus ED described with reference to FIGS. 7A and 7B will be mainly described.

Referring to FIG. 15, an electronic apparatus ED-A according to an embodiment may include a protective layer PF, a window WL, a display module DM, an optical layer RPL, a lower film PM, a plate SP, a support part DE, and a housing HAU-A. The electronic apparatus ED-A may further include a cushion layer CS and a printing layer BM.

The housing HAU-A according to this embodiment may include a lower portion H-B, a lateral portion H-S extending from the lower portion H-B in the third direction DR3, and a protruding portion H-P protruding from the lateral portion H-S.

The protruding portion H-P according to an embodiment may include a first surface H-1 that faces a top surface of the lateral portion H-S, a second surface H-2 that connects the first surface H-1 to an outer surface of the lateral portion H-S, and a third surface H-3 that connects the first surface H-1 to the top surface of the lateral portion H-S.

In an embodiment, the first surface H-1 may have predetermined curvature. Thus, aesthetic properties of the electronic apparatus ED-A may be improved when a user views the electronic apparatus ED-A in the third direction DR3.

Referring to FIG. 16, an electronic apparatus ED-B according to an embodiment may include a protective layer PF, a window WL, a display module DM, an optical layer RPL, a lower film PM, a plate SP, a support part DE, and a housing HAU-B. The electronic apparatus ED-B may further include a cushion layer CS and a printing layer BM.

The housing HAU-B according to this embodiment may include a lower portion H-B, a lateral portion H-S extending from the lower portion H-B in the third direction DR3, and a protruding portion H-P protruding from the lateral portion H-S.

The protruding portion H-P may include a first surface H-1 that faces a top surface of the lateral portion H-S, a second surface H-2 that connects the first surface H-1 to an outer surface of the lateral portion H-S, and a third surface H-3 that connects the first surface H-1 to an inner surface of the lateral portion H-S.

In this embodiment, the first surface H-1 may extend in the second direction DR2 to be parallel to the top surface of the lateral portion H-S. According to an embodiment, an angle between the first surface H-1 and the second surface H-2 may be an obtuse angle, and an angle between the first surface H-1 and the third surface H-3 may be a right angle.

In this embodiment, the protective layer PF may expose the first surface H-1 of the protruding portion H-P. That is, the protective layer PF may be spaced apart from the first surface H-1 of the protruding portion H-P, when viewed in the third direction DR3.

Referring to FIG. 17, a cushion layer CS-C according to an embodiment may be in contact with a top surface of a third sidewall portion S-L and an inner surface of the third sidewall portion S-L. FIG. 17 illustrates the third sidewall portion S-L as an example. The cushion layer CS-C may be in contact with a top surface and an inner surface of each of the sidewall portions S1-U, S1-B, S2-U, S2-B, S-R1, S-R2 and S-C described with reference to FIG. 6A.

According to this embodiment, the third sidewall portion S-L may be prevented from colliding with a protective layer PF when an electronic apparatus ED-C is folded.

According to the embodiment of the invention, the sidewall portions of the support plate disposed at the lower portion of the display module may be bent to support the display module. Thus, the space in which the separate support part is disposed may be omitted. Accordingly, the dead space may be reduced to improve the aesthetic properties of the electronic apparatus.

Although the embodiments of the present invention have been described, it is understood that the present invention should not be limited to these embodiments but various changes and modifications can be made by one ordinary skilled in the art within the spirit and scope of the present invention as hereinafter claimed.

Therefore, the technical scope of the invention is not limited to the contents described in the detailed description of the specification, but should be determined by the claims.

What is claimed is:

1. An electronic apparatus comprising:
a display module comprising a folding area, which is foldable around a folding axis extending in a first direction, and a first non-folding area and a second non-folding area, which are spaced apart from each other with the folding area therebetween in a second direction crossing the first direction;
a window disposed on the display module;
a protective layer disposed on the window;
a support plate disposed below the display module; and
a housing in which the display module and the support plate are accommodated,
wherein the support plate comprises:
a bottom portion facing a lower portion of the housing; and
sidewall portions, each of which is bent from the bottom portion to face a lateral portion of the housing,
wherein each of the sidewall portions is disposed between a side surface of the display module and the lateral portion of the housing.

2. The electronic apparatus of claim 1, wherein the support plate comprises:
a matrix comprising a filler; and
a reinforced fiber composite material disposed inside the matrix and comprising at least one of a reinforced fiber or a carbon fiber.

3. The electronic apparatus of claim 1, wherein the sidewall portions are bent from the bottom portion with predetermined curvature.

4. The electronic apparatus of claim 1, wherein an angle between the bottom portion and each of the sidewall portions is a right angle.

5. The electronic apparatus of claim 1, further comprising a lower plate disposed below the support plate,
wherein the lower plate has a plate shape extending in the first direction and the second direction.

6. The electronic apparatus of claim 5, wherein the lower plate comprises at least one of stainless steel or aluminum.

7. The electronic apparatus of claim 5, wherein the lower plate comprises:
a first plate overlapping the first non-folding area; and
a second plate spaced apart from the first plate with the folding area therebetween, and overlapping the second non-folding area.

8. The electronic apparatus of claim 5, wherein a sum of a thickness of the bottom portion of the support plate and a thickness of the lower plate is about 50 μm to about 250 μm.

9. The electronic apparatus of claim 1, further comprising a cushion layer disposed between the side surface of the display module and each of the sidewall portions,
wherein the cushion layer is in contact with the sidewall portions.

10. The electronic apparatus of claim 1, wherein each of the sidewall portions defines a plurality of holes adjacent to a boundary of the bottom portion, and extending in a same direction as an extending direction of the boundary.

11. The electronic apparatus of claim 10, further comprising a cover tape disposed on an outside of the sidewall portions adjacent to the housing, and configured to cover the holes.

12. The electronic apparatus of claim 10, further comprising a cushion layer disposed between the lateral portion of the housing and each of the sidewall portions,
wherein the cushion layer is in contact with the sidewall portions.

13. The electronic apparatus of claim 1, further comprising a cushion layer, which is in contact with a top surface of each of the sidewall portions and an inner surface of each of the sidewall portions.

14. The electronic apparatus of claim 1, further comprising a printing layer disposed along an edge of the protective layer and having a predetermined color.

15. The electronic apparatus of claim 14, wherein a top surface of each of the sidewall portions is in contact with the printing layer.

16. The electronic apparatus of claim 1, wherein the housing further comprises a protruding portion protruding from a top surface of the lateral portion,
wherein the protruding portion comprises a first surface facing the top surface of the lateral portion, a second surface configured to connect the first surface to an outer surface of the lateral portion, and a third surface configured to connect the first surface to the top surface of the lateral portion,
wherein an angle between the second surface and the first surface is an obtuse angle, and an angle between the third surface and the first surface is a right angle.

17. The electronic apparatus of claim 16, wherein the first surface is parallel to the top surface of the lateral portion.

18. The electronic apparatus of claim 17, wherein the first surface and the protective layer do not overlap each other in a plan view.

19. The electronic apparatus of claim 16, wherein the first surface has predetermined curvature.

20. The electronic apparatus of claim 16, wherein the protective layer is disposed on a portion, which is exposed from the protruding portion, of the top surface of the lateral portion.

21. The electronic apparatus of claim 1, wherein the display module comprises a first area comprising the first non-folding area, the folding area, and the second non-folding area, a bending area, and a second area, which are arranged in the second direction,
wherein the bending area is bent around a bending axis extending in the first direction such that the second area overlaps the first area in a plan view,
wherein a width of the first area is greater than a width of each of the bending area and the second area in the first direction.

22. The electronic apparatus of claim 21, wherein the sidewall portions are spaced apart from each other with the bending area therebetween in a state in which the bending area is bent.

23. The electronic apparatus of claim 21, further comprising a support part disposed on the lower portion of the housing, which is adjacent to the bending area.

24. The electronic apparatus of claim 1, wherein the sidewall portions are not disposed on an area overlapping the folding area.

25. An electronic apparatus comprising:
a display module comprising a folding area, which is foldable around a folding axis extending in a first direction, and a first non-folding area and a second non-folding area, which are spaced apart from each other with the folding area therebetween in a second direction crossing the first direction;
a window disposed on the display module;
a protective layer disposed on the window;
a lower film disposed below the display module;
a support plate disposed below the lower film and defining a groove recessed in at least a portion of the support plate;
a coupling part extending along an edge of the support plate and comprising a protrusion portion coupled to the groove; and
a housing in which the display module and the support plate are accommodated,
wherein the coupling part is disposed between a side surface of the display module and the housing.

26. The electronic apparatus of claim 25, wherein each of the groove and the protrusion portion is provided in plurality, and the plurality of grooves are arranged to be spaced apart from each other along an edge of the support plate,
wherein the coupling part comprises a body extending along the edge of the support plate, and the protrusion portions protruding from the body,
wherein the protrusion portions are inserted into the grooves, respectively.

27. The electronic apparatus of claim 25, wherein the groove extends along the edge of the support plate, and
the coupling part comprises a resin.
